(19) United States
(12) Patent Application Publication
(10) Pub. No.: US 2020/0017623 A1
(43) Pub. Date: Jan. 16, 2020

(54) BLUE LED CURE ON DEMAND COMPOSITIONS

(71) Applicant: 3M INNOVATIVE PROPERTIES COMPANY, St. Paul, MN (US)

(72) Inventors: Sheng Ye, Woodbury, MN (US); Ying Lin, Woodbury, MN (US); Michael E. Griffin, Maplewood, MN (US); Dennis R. Keicher, River Falls, WI (US); Jay S. Schlechte, Oakdale, MN (US); Paul J. Homnick, Lake Elmo, MN (US); Richard S. Smith, West St. Paul, MN (US); Thomas P. Klun, Lakeland, MN (US); Richard J. Pokorny, Maplewood, MN (US); Steven Y. Yu, St. Paul, MN (US); Patricia M. Savu, Maplewood, MN (US); Michael A. Kropp, Cottage Grove, MN (US); Ian Dailey, Maplewood, MN (US); Charlie P. Blackwell, St. Paul, MN (US)

(21) Appl. No.: 16/491,051

(22) PCT Filed: Mar. 8, 2018
(86) PCT No.: PCT/US2018/021510

§ 371 Date: Sep. 4, 2019

Related U.S. Application Data
(60) Provisional application No. 62/468,638, filed on Mar. 8, 2017.
(60) Provisional application No. 62/568,637, filed on Oct. 5, 2017.

(51) Int. Cl. C08F 290/06; C09D 175/16; C09D 4/00; C08L 75/16; C09J 4/00; C09J 151/08; F21V 29/70; F21V 29/60; B05D 3/06; B05D 7/16; B29C 35/08

(52) U.S. Cl. CPC C08F 290/067; C09D 175/16; C09D 4/00; C08L 75/16; C09J 4/00; C08K 2003/265; F21V 29/70; F21V 29/60; B05D 3/067; B05D 7/16; B29C 35/0805; C09J 151/08

(57) ABSTRACT

The disclosure relates to compositions, methods of applying such compositions, and methods for curing such compositions to a depth of cure of up to about 30 mm within about 0.5 second to about two minutes per light exposure area.

### BACKGROUND

There are varieties of automotive compositions on the market, the curing of all of which is triggered by curing mechanisms that depend on a catalyst, moisture and/or heat. It is well known that these curing mechanisms either provide the user with a limited amount of work time because the curing speed is relatively fast; or with a relatively long work time because the curing speed is relatively slow. For example, most one-part compositions have long work time between 10-45 minutes, but cure slowly within hours. Under these circumstances, any sealed parts have to wait before they can be painted, resulting in a loss of efficiency and productivity for the user. In contrast, most two-part compositions can cure as fast as 15 minutes, but have very short work time around 5-10 minutes. Under these circumstances, a user may not have enough time to work around on

the method of Embodiment 1, wherein the composition further comprises at least one of an adhesion promoter (e.g., about 3 wt. % to about 50 wt. %), diluents (e.g., about 10 wt. % to about 80 wt. %), a long alkyl chain (meth)acrylate (e.g., about 0.3 wt. % to about 10 wt. %), a fluorinated (meth)acrylate (e.g., about 0.3 wt. % to about 10 wt. %), a corrosion inhibitor (e.g., about 0.5 wt. % to about 10 wt. %), a photobleaching agent (e.g., about 1 ppm to about 200 ppm), a photosensitizer (e.g., about 1 ppm to about 200 ppm), fillers (e.g., about 0.1 wt. % to about 30 wt. %), monothiols, polythiols (e.g., about 0.5 wt. % to about 30 wt. % of at least one monothiol, polythiol or a combination of mono- and polythiol), and a plasticizer (e.g., about 1 wt. % to about 40 wt. %).

Embodiment 3 relates to the method of Embodiments 1-2, wherein the cured composition has a 180 degree T-peel strength to unpainted steel of greater than 1.5 N/mm.

Embodiment 4 relates to the method of Embodiments 1-3, wherein the cured composition has less than 40% corrosion on unpainted steel when exposed to salt spray according to ASTM B117 for three weeks.

Embodiment 5 relates to the method of Embodiments 1-4, wherein the composition comprises about 5 wt. % to about 85 wt. % urethane acrylate component.

Embodiment 6 relates to the method of Embodiments 1-5, wherein the composition comprises about 0.1 wt. % to about 8 wt. % photoinitiator.

Embodiment 7 relates to the method of Embodiments 1-6, wherein the composition is applied to the substrate at a thickness of about 0.1 mm to about 50 mm.

Embodiment 8 relates to the method of Embodiments 1-7, wherein the composition is applied to the substrate at a thickness of about 30 mm.

Embodiment 9 relates to the method of Embodiments 1-8, wherein the urethane acrylate component comprises an aliphatic urethane acrylate, an aromatic urethane acrylate, or a combination of an aliphatic urethane acrylate and an aromatic urethane acrylate.

Embodiment 10 relates to the method of Embodiments 1-9, wherein the photoinitiator comprises a quinone, a phosphine oxide or a phosphinate.

Embodiment 11 relates to the method of Embodiments 1-10, wherein the photoinitiator comprises

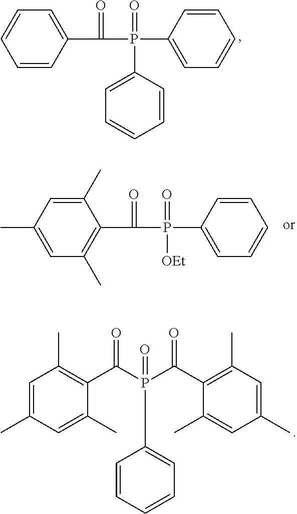

Embodiment 12 relates to the method of Embodiment 2-11, wherein the filler comprises calcium carbonate (CaCO₃), silica, glass bubbles, glass flakes, or talc.

Embodiment 13 relates to the method of Embodiments 2-12, wherein the monothiol is a monothiol of the formula (I): R¹—SH wherein R¹ is (CH₃)—(CH₂)ᵣ—X¹—(CH₂)ᵣ—, wherein r is an integer from 0 to 4 and X¹ is —O—, —S— or C(R²)₂, wherein R² is H or (C₁-C₆) alkyl.

Embodiment 14 relates to the method of Embodiments 2-12, wherein the polythiols are at least one of dithiols, trithiols, and tetrathiols.

Embodiment 15 relates to the method of Embodiment 14, wherein the polythiol is a dithiol of the formula (II): HS—R³—SH wherein R³ is —[(—CH₂—)ₛ—X²—]_{q}—(CH₂)ᵣ—, wherein s is an integer from 1 to 4, r is an integer from 1 to 4, q is an integer from 1 to 3, and X is —O— or —S—.

Embodiment 16 relates to the method of Embodiment 15, wherein the dithiol comprises dimercaptodiethylsulfide (DMDS); dimercaptodioxaoctane (DMDO); or 1,5-dimercapto-3-oxapentane.

Embodiment 17 relates to the method of Embodiments 2-16, wherein the adhesion promoter comprises an acid-functional monomer.

Embodiment 18 relates to the method of Embodiments 2-16, wherein the adhesion promoter comprises a hydroxyl-functional monomer.

Embodiment 19 relates to the method of Embodiments 2-16, wherein the adhesion promoter comprises a nitrogen-containing functional monomer.

Embodiment 20 relates to the method of Embodiments 2-16, wherein the adhesion promoter comprises acrylic acid (AA), methacrylic acid (MAA), beta-carboxyethyl acrylate (B-CEA); 2-hydroxy ethyl methacrylate (HEMA) Succinate; 2-hydroxy ethyl acrylate (HEA), 2-hydroxy ethyl methacrylate (HEMA)2-hydroxy ethyl methacrylate (HEMA) phosphate; (meth) acrylic phosphonic acids and esters; (meth) acrylic phosphoric acids and esters; (3-acryloxypropyl)trimethoxysilane, methacryloxypropyltrimethoxysilane, (3N-vinyl-caprolactam, N,N-dimethyl acrylamide, diethylaminoethyl methacrylate, vinyl carbazole, 2-vinylpyridineor 1-vinyl-2-pyrrolidone or combinations thereof.

Embodiment 21 relates to the method of Embodiments 1-20, wherein the substrate is an automotive body part requiring sealing.

Embodiment 22 relates to the method of Embodiment 21, where in the automotive body parts include door, fender, quarter panel, hood, deck lid, roof, floor, rocker panel, wheel house, cowl, and frame/structural members.

Embodiment 23 relates to the method of Embodiments 1-22, wherein the light-emitting curing device comprises an array of light emitting diodes.

Embodiment 24 relates to the method of Embodiment 23, wherein the light emitting diodes are arranged in a plurality of columns, each column comprising a plurality of light emitting diodes having a pitch within each column of from about 1.5 mm to about 12 mm.

Embodiment 25 relates to the method of Embodiment 24, wherein each light emitting diode column may be aligned with adjacent columns, staggered or offset.

Embodiment 26 relates to the method of Embodiments 1-25, wherein the light-emitting curing device is placed substantially in close proximity of, or in direct contact with the composition.

Embodiment 27 relates to a method comprising: curing a composition comprising a urethane acrylate component; and a photoinitiator having an extinction coefficient of from about 10 to about 2000 L/mol·cm at a wavelength from about 400 nm to about 500 nm in an amount of from about 0.1 wt. % to about 8 wt. %; wherein the composition cures to a depth of cure of up to about 30 mm within about 0.5 second to about two minutes per light exposure area.

Embodiment 28 relates to a curing device comprising: a curing head including: an emitter comprising an elongate array of light emitting diodes (LEDs) arranged in alternating columns, wherein rows of LEDs in each individual column are offset from each other by about 1.5 mm to about 12 mm and each individual LED is offset by about 1.5 mm to about 12 mm from each other; a chassis to which the curing head is mounted; and a housing at least partially enclosing the chassis and curing head; wherein the curing device emits light at a wavelength of from about 260 nm to about 550 nm; and the curing device has a radiometric energy of about at least about 0.1 W/cm².

Embodiment 29 relates to the curing device of Embodiment 28, wherein the curing device emits light at a wavelength of from about 400 nm to about 500 nm.

Embodiment 30 relates to the curing device of Embodiments 28-29, further comprising at least one heat sink bank mounted to the chassis, opposite the emitter, wherein the chassis is in direct or indirect thermal communication with the emitter.

Embodiment 31 relates to the curing device of one of claims 28-30, further comprising one or more fans mounted on the curing head to direct an airflow across the emitter or heat sink assembly.

Embodiment 32 relates to a composition comprising: a urethane acrylate (e.g., multi-functional urethane acrylate); a reactive diluent; an adhesion promoter; a photoinitiator having an extinction coefficient of from about 10 to about 2000 L/mol·cm at a wavelength from about 400 nm to about 500 nm; a photobleaching agent; a photosensitizer; and a filler.

Embodiment 33 relates to the composition of Embodiment 32, wherein the reactive diluent is a low viscosity acrylate monomer.

Embodiment 34 relates to the composition of Embodiment 32, wherein the adhesion promoter is an acid-functional monomer.

Embodiment 35 relates to the composition of Embodiment 32, wherein the adhesion promoter comprises a hydroxyl-functional monomer.

Embodiment 36 relates to the composition of Embodiment 32, wherein the adhesion promoter comprises a nitrogen-containing functional monomer.

Embodiment 37 relates to the composition of Embodiment 32, wherein the adhesion promoter comprises acrylic acid (AA), methacrylic acid (MAA), beta-carboxyethyl acrylate (B-CEA); 2-hydroxy ethyl methacrylate (HEMA) Succinate; 2-hydroxy ethyl acrylate (HEA), 2-hydroxy ethyl methacrylate (HEMA)2-hydroxy ethyl methacrylate (HEMA) phosphate; (meth) acrylic phosphonic acids and esters; (meth) acrylic phosphoric acids and esters; (3-acryloxypropyl)trimethoxysilane, methacryloxypropyltrimethoxysilane, (3N-vinyl-caprolactam, N,N-dimethyl acrylamide, diethylaminoethyl methacrylate, vinyl carbazole, 2-vinylpyridineor 1-vinyl-2-pyrrolidone or combinations thereof.

Embodiment 38 relates the composition of Embodiments 32-37, wherein the composition comprises about 5 wt. % to about 85 wt. % multi-functional urethane acrylate; about 10 wt. % to about 80 wt. % reactive diluent; about 3 wt. % to about 50 wt. % adhesion promoter; about 0.1 wt. % to about 8 wt. % photoinitiator; about 1 ppm to about 200 ppm photobleaching agent; about 1 ppm to about 200 ppm photosensitizer; and about 0.1 wt. % to about 30 wt. % filler.

Embodiment 39 relates to the composition of one of Embodiments 32-38, wherein the composition comprises about 20 wt. % to about 45 wt. % multi-functional urethane acrylate; about 25 wt. % to about 50 wt. % reactive diluent; about 10 wt. % to about 30 wt. % adhesion promoter; about 3 wt. % to about 5 wt. % photoinitiator; about 5 ppm to about 50 ppm photobleaching agent; about 5 ppm to about 50 ppm photosensitizer; and about 1 wt. % to about 10 wt. % filler.

Embodiment 40 relates to the composition of Embodiments 32-39, further comprising a long alkyl chain (meth)acrylate.

Embodiment 41 relates to the composition of Embodiment 40, wherein the composition comprises about 0.3 to about 10 wt. % long alkyl chain (meth)acrylate.

Embodiment 42 relates to the composition Embodiments 32-41, further comprising a corrosion inhibitor.

Embodiment 43 relates to the composition of Embodiment 42, wherein the composition comprises about 0.5 to about 10 wt. % corrosion inhibitor.

Embodiment 44 relates to the composition of Embodiments 32-43, wherein the urethane acrylate comprises an aliphatic urethane acrylate, an aromatic urethane acrylate, or a combination of an aliphatic urethane acrylate and an aromatic urethane acrylate.

Embodiment 45 relates to the composition of Embodiment 32-44, wherein the photoinitiator comprises a quinone, a phosphine oxide or a phosphinate.

Embodiments 46 relates to the composition of Embodiments 32-45, wherein the photoinitiator comprises

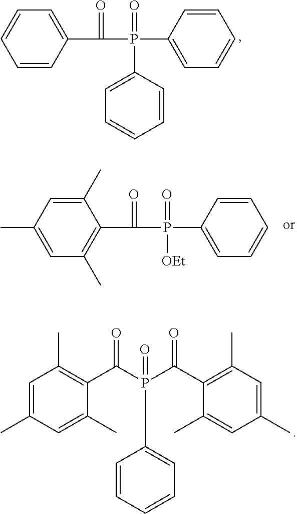

Embodiment 47 relates to the composition of Embodiments 32-45, wherein the photosensitizer comprises camphorquinone.

Embodiment 48 relates to the composition of Embodiments 32-47, wherein the photobleaching agent comprises Disperse blue 60, or oil blue A.

Embodiment 49 relates to the composition of Embodiments 32-48, wherein the filler comprises calcium carbonate (CaCO₃), silica, glass bubbles, glass flakes or talc.

Embodiment 50 relates to the composition of Embodiments 32-49, further comprising a monothiol of the formula (I): R¹—SH wherein R¹ is (CH₃)—(CH₂)ᵣ—X¹—(CH₂)ᵣ—, wherein r is an integer from 0 to 4 and X¹ is —O—, —S— or C(R²)₂, wherein R² is H or (C₁-C₆) alkyl.

Embodiment 51 relates to the composition of Embodiment 32-49, further comprising a polythiol.

Embodiment 52 relates to the composition of Embodiment 51, wherein the polythiol is a dithiol of the formula (II): HS—R³—SH wherein R³ is —[(—CH₂—)ₛ—X²—]_{q}—(CH₂)ᵣ—, wherein s is an integer from 1 to 4, r is an integer from 1 to 4, q is an integer from 1 to 3, and X is —O— or —S—.

Embodiment 53 relates to the composition of Embodiment 51, wherein the dithiol comprises dimercaptodiethylsulfide (DMDS); dimercaptodioxaoctane (DMDO); or 1,5-dimercapto-3-oxapentane.

Embodiment 54, therefore, is directed to a method comprising: applying a sealing composition to a substrate, the sealing composition comprising a urethane acrylate component; and a photoinitiator having an extinction coefficient of from about 10 to about 2000 L/mol·cm at a wavelength from about 400 nm to about 500 nm in an amount of from about 0.1 wt. % to about 10 wt. %; and curing the sealing composition using a light-emitting curing device emitting light at a wavelength of from about 260 to about 550 nm; wherein the sealing composition cures to a depth of cure of up to about 30 mm within about 0.5 second to about two minutes per light exposure area.

Embodiment 55 relates to the method of Embodiment 54, wherein the sealing composition comprises about 30 wt. % to about 99.9 wt. % urethane acrylate component.

Embodiment 56 relates to the method of Embodiment 54-55, wherein the sealing composition comprises about 0.5 wt. % to about 10 wt. % photoinitiator.

Embodiment 57 relates to the method of Embodiments 54-56, wherein the sealing composition is applied to the substrate at a thickness of about 0.1 mm to about 50 mm. In some embodiments, the sealing composition of Embodiments 54-57 is applied to the substrate at a thickness of about 30 mm.

Embodiment 58 relates to the method of Embodiments 54-57, wherein the urethane acrylate component comprises an aliphatic urethane acrylate, an aromatic urethane acrylate, or a combination of an aliphatic urethane acrylate and an aromatic urethane acrylate.

Embodiment 59 relates to the method of Embodiments 54-58, wherein the photoinitiator comprises a quinone, a phosphine oxide or a phosphinate.

Embodiment 60 relates to the method of Embodiments 54-59, wherein the photoinitiator comprises camphorquinone.

Embodiment 61 relates to the method of Embodiments 54-59, wherein the photoinitiator comprises:

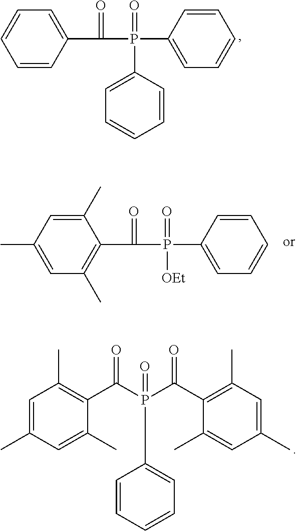

Embodiment 62 relates to the method of Embodiments 54-61, wherein the sealing composition further comprises at least one of photosensitizers, fillers, monothiols, polythiols, plasticizers, adhesion promoters, and diluents.

Embodiment 63 relates to the method of Embodiment 62, wherein the sealing composition comprises about 0.05 wt. % to about 5% wt. % photosensitizer, about 1 wt. % to about 70 wt. % filler; about 0.5 wt. % to about 30 wt. % of at least one monothiol, polythiol or a combination of mono- and polythiol; about 1 wt. % to about 40 wt. % plasticizer; or about 0.3 wt. % to about 20 wt. % adhesion promoter.

Embodiment 64 relates to the method of Embodiment 62, wherein the filler comprises calcium carbonate (CaCO₃) or silica.

Embodiment 65 relates to the method of Embodiment 62, wherein the monothiol is a monothiol of the formula (I):

R¹—SH

wherein R¹ is (CH₃)—(CH₂)ᵣ—X¹—(CH₂)ᵣ—, wherein r is an integer from 0 to 4 and X¹ is —O—, —S— or C(R²)₂, wherein R² is H or (C₁-C₆) alkyl.

Embodiment 66 relates to the method of Embodiment 62, wherein the polythiols are at least one of dithiols, trithiols, and tetrathiols.

Embodiment 67 relates to the polythiols of Embodiment 66, wherein the polythiol is a dithiol of the formula (II):

HS—R³—SH

wherein R³ is —[(—CH₂—)ₛ—X²—]_{q}—(CH₂)ᵣ—, wherein s is an integer from 1 to 4, r is an integer from 1 to 4, q is an integer from 1 to 3, and X is —O— or —S—.

Embodiment 68 relates to the method of Embodiment 67, wherein the dithiol comprises dimercaptodiethylsulfide (DMDS); dimercaptodioxaoctane (DMDO); or 1,5-dimercapto-3-oxapentane.

Embodiment 69 relates to the method of Embodiment 62, wherein the adhesion promoter comprises an acid-functional monomer, a basic functional monomer or a silane.

Embodiment 70 relates to the method of Embodiment 62, wherein the adhesion promoter comprises acrylic acid (AA), methacrylic acid (MAA), beta-carboxyethyl acrylate (B-CEA), 2-hydroxy ethyl methacrylate (HEMA) phosphate; (3-acryloxypropyl)trimethoxysilane, methacryloxypropyltrimethoxysilane, N-(3-acryloxy-2-hydropropyl)-3-aminopropyltriethoxysilane, (3-acryloxypropyl)methyldimethoxysilane, (methacryloxymethyl)methyldiethoxysilane, methacryloxypropyldimethylethoxysilane, methacryloxypropyldimethylmethoxysilane, N-vinyl-caprolactam, N,N-dimethyl acrylamide, acrylamide, acrylonitrile, N-tert-butylacrylamide, 2-tert-butylaminoethyl methacrylate, diethylaminoethyl methacrylate, dimethylaminoethyl methacrylate, N-isopropylacrylamide, methacrylonitrile, vinyl carbazole, 2-vinylpyridine, 4-vinylpyridine or 1-vinyl-2-pyrrolidone or combinations thereof.

Embodiment 71 relates to the method of Embodiments 54-70, wherein the substrate is an automotive body part requiring sealing.

Embodiment 72 relates to the method of Embodiment 71, wherein the automotive body part is at least one of a truck, a door, a deck lid, a hood, a lift age, a tail gate, and a rear body panel.

Embodiment 73 relates to the method of Embodiments 54-72, wherein the light-emitting curing device comprises an array of light emitting diodes.

Embodiment 74 relates to the method of Embodiment 73, wherein the light emitting diodes are arranged in a plurality of columns, each column comprising a plurality of light emitting diodes having a pitch within each column of from about 1.5 mm to about 12 mm.

Embodiment 75 relates to the method of Embodiments 54-74, wherein the light-emitting curing device is placed substantially in direct contact with the sealing composition.

Embodiment 76 relates to a method comprising: curing a sealing composition comprising a urethane acrylate component; and a photoinitiator having an extinction coefficient of from about 10 to about 2000 L/mol·cm at a wavelength from about 400 nm to about 500 nm in an amount of from about 0.1 wt. % to about 10 wt. %; wherein the sealing composition cures to a depth of cure of up to about 30 mm within about 0.5 second to about two minutes per light exposure area.

Embodiment 77 relates to a curing device comprising: a curing head including: an emitter comprising an elongate array of light emitting diodes (LEDs) arranged in alternating columns, wherein rows of LEDs in each individual column are offset from each other by about 1.5 mm to about 12 mm and each individual LED is offset by about 1.5 mm to about 12 mm from each other; a chassis on which the curing head is mounted; and a housing at least partially enclosing the chassis and curing head; wherein the curing device emits light at a wavelength of from about 260 nm to about 550 nm; and the curing device has a radiometric energy of about at least about 0.1 W/cm².

Embodiment 78 relates to the curing device of Embodiment 77, further comprising at least one heat sink bank mounted to the chassis, opposite the emitter, wherein the chassis is in direct or indirect thermal communication with the emitter.

Embodiment 79 relates to the curing device of Embodiments 77-78, further comprising one or more fans mounted on the curing head to direct an airflow across the emitter.

These and other aspects of the invention will be apparent from the detailed description below. In no event, however, should the above summaries be construed as limitations on the claimed subject matter, which subject matter is defined solely by the attached claims, as may be amended during prosecution.

### DESCRIPTION OF THE FIGURES

The drawings illustrate generally, by way of example, but not by way of limitation, various embodiments discussed in the present document.

FIG. 1 is a schematic view of a sealing system including a curing head of the present disclosure including an air-cooled, light-emitting curing device.

FIG. 2 is a schematic cross-sectional view of an embodiment of the curing head of FIG. 1 comprising a light “wand” including an array of light emitting diodes.

FIG. 3 is a schematic cross-sectional view of an embodiment of the curing head of FIG. 1 comprising a light “wand” and a spotlight. The spotlight is optional.

FIG. 4 is a close-up view of a light emitting diode array having staggered LEDs. Linear or other geometric LED arrangements (e.g., radial) are also contemplated.

FIG. 5 is a perspective view of an example heat sink that can be used in the curing heads of FIGS. 2 and 3.

FIG. 6 is a perspective view of a curing head of the present disclosure having a housing in which an array of light emitting diodes is located.

FIG. 7 is a perspective view of the curing head of FIG. 6 showing the housing partially exploded to expose fans positioned on opposite sides of a heat sink.

FIG. 8 is a block diagram of a system circuit architecture for an exemplary curing head of the present disclosure.

Repeated use of reference characters in the specification and drawings is intended to represent the same or analogous features or elements of the disclosure. It should be understood that numerous other modifications and examples can be devised by those skilled in the art, which fall within the scope and spirit of the principles of the disclosure. Figures may not be drawn to scale.

### DESCRIPTION

One of the challenges with light-cure on demand compositions is their cure speed at a given depth of application, especially when a highly filled opaque/colored system is used. To resolve this issue, the compositions of the various embodiments described herein employ a light-emitting curing device that balances the depth of cure and cure speed. Theoretically, longer wavelength light, such as visible light, penetrates deeper than short wavelength light, such as UV. However, short wavelength light has higher energy and more efficiently trigger the initiator, compared with longer wavelength light. In this case, there is a fine balance between depth of cure and cure speed by designing the right wavelength lamp and composition.

The various embodiments of the described herein employ “blue wavelength” because such light can cure significantly deep applications of the various compositions described herein, even when the compositions are highly filled opaque/colored. The light-emitting curing device of the various embodiments described herein provides a flexible assembly of different geometries and a high conversion efficiency from electricity to radiant energy, which enables the design of cordless battery rechargeable device.

In addition, the compositions of the various embodiments described herein can accelerate productivity so that parts, such as vehicle parts and the vehicles into which they are incorporated, can be moved out of a body shop faster and bring more profit to shop owners; could reduce inventory due to the multiple use capability to potentially replace existing compositions; and provide true global performance at all temperature ranges and humidity environments. An additional benefit of the compositions of the various embodiments described herein is that they not only bond strongly to bare metal, but they also do it in a very short period of time, in some instances in less than five seconds and a T-peel strength of greater than 3 N/mm.

Various embodiments described herein are directed to a composition comprising: a urethane acrylate component; and a photoinitiator.

The composition comprises a urethane acrylate component in an amount of from about 5 wt. % to about 85 wt. % of the total weight of the composition; and a photoinitiator having an extinction coefficient of from about 10 to about 2000 L/mol·cm (e.g., about 50 to about 500 L/mol·cm or about 100 to about 700 L/mol·cm) at a wavelength from about 400 nm to about 500 nm in an amount of from about 0.1 wt. % to about 10 wt. %.

The compositions can further comprise one or more long alkyl chain (meth)acrylates. When present, the optional long alkyl chain (meth)acrylate is present in an amount of from about 0 wt. % to about 10 wt. % (e.g., about 0.3 wt. % to about 10 wt. % or about 2 wt. % to about 5 wt. %) of the total weight of the composition.

The compositions can further comprise one or more fluorinated (meth)acrylates. When present, the optional fluorinated (meth)acrylate is present in an amount of from about 0 wt. % to about 10 wt. % (e.g., about 0.3 wt. % to about 10 wt. % or about 2 wt. % to about 5 wt. %) of the total weight of the composition.

The compositions can further comprise one or more corrosion inhibitors. When present, the optional corrosion inhibitor is present in an amount of from about 0 wt. % to about 10 wt. % (e.g., about 0.5 wt. % to about 10 wt. % or about 1 wt. % to about 5 wt. %) of the total weight of the composition.

The compositions can further comprise one or more photobleaching agents. When present, the optional photobleaching agent in present in an amount of from about 1 ppm to about 200 ppm (e.g., about 5 to about 50 ppm) based on the total weight of the composition.

The compositions can further comprise one or more photosensitizers in an amount of from about 1 ppm to about 200 ppm (e.g., about 5 to about 50 ppm).

The compositions can further comprise a filler component that makes up from about 1 wt. % to about 70 wt. % (e.g., about 0.1 wt. % to about 20 wt. %, or about 10%) of the total weight of the composition. The filler can be transparent, translucent, opaque or can comprise mixtures of fillers that are opaque and/or transparent such that a filler composition can span the entire spectrum from transparent to opaque and everywhere in between.

The compositions can further comprise at least one monothiol, polythiol or a combination of mono- and polythiol, in an amount of from about 0.5 wt. % to about 30 wt. % of the total weight of the composition.

The compositions can further comprise at least one plasticizer in an amount of from about 1 wt. % to about 40 wt. % of the total weight of the composition.

The composition can further comprise at least one adhesion promoter in an amount of from about 3 wt. % to about 50 wt. % of the total weight of the composition.

The compositions can further comprise at least one polymerizable or non-polymerizable diluent from about 10 wt. % to about 80 wt. %.

The compositions comprise combinations of the foregoing urethane acrylate component and photoinitiator and at least one of the one or more long alkyl chain (meth)acrylates, one or more corrosion inhibitors, one or more photobleaching agents, one or more photosensitizers, one or more fillers, one or more monothiols, polythiols or a combination of mono- and polythiols, one or more plasticizers, one or more adhesion promoters, and one or more diluents.

The compositions of the various embodiments described herein advantageously, and unexpectedly, can be polymerized/cured to a depth of cure of up to about 30 mm within about 0.5 second to about two minutes; about 1 second to about 5 seconds; about 1 second to about 10 seconds; about 5 seconds to about 30 seconds; about 30 seconds to about two minutes; or about 45 seconds to about 1.5 minutes per exposure area when the composition is irradiated with a light-emitting curing device (described in greater detail herein) emitting a wavelength of light of from about 260 nm to about 550 nm (e.g., from about 350 nm to about 550 nm, about 400 nm to about 500 nm; about 425 nm to about 475 nm; or about 440 nm to about 460 nm) and having a radiometric energy of about at least about 0.1 W/cm² (e.g., about 0.5 W/cm² to about 5 W/cm²; about 1 W/cm² to about 3 W/cm²; about 1 W/cm² to about 2 W/cm²; or about 0.5 W/cm² to about 2 W/cm²).

The compositions of the various embodiments described herein advantageously exhibit a 180 degree T-peel strength to unpainted steel of greater than 1.5 N/mm (e.g., greater than 2 N/mm, greater than 3 N/mm, greater than 5 N/mm; from about 1.5 N/mm to about 5 N/mm, about 2 N/mm to about 6 N/mm or about 3 N/mm to about 5 N/mm) as determined by 180 degree T-peel at the rate of 2.0 inch/min.

The compositions of the various embodiments described herein advantageously are able to protect unpainted steel such that less than 40% (e.g., less than 30%, less than 20%, less than 10%, less than 5% or less than 1%) corrosion as determined by ASTM B117.

In some embodiments, the automotive parts that are sealed with the compositions of the various embodiments described herein are optionally treated with a suitable primer, such as 8682 (a single step primer) or AP-111, both available from 3M, St. Paul, Mn. And the composition is, in turn, applied as a layer on the primer, in some embodiments a layer that substantially covers the primer.

It should be understood that the rate at which compositions of the various embodiments described herein can be polymerized/cured can depend on the presence of certain components, when present, and the amount of those components. For example, the polymerization/cure rate of the compositions of the various embodiments described herein can depend on the amount and/or type of filler contained in the compositions, when a filler component is used. Thus, for example, if the compositions are loaded with a relatively large amount of an opaque filler component (e.g., 70 wt. %), the curing time might be closer to 2 minutes per exposure area, even at a 30 mm depth, But if the filler component is transparent or translucent, the curing time might be closer to 1 second per exposure area, even if the compositions are loaded with a relatively large amount of a filler component (e.g., 70 wt. %).

As used herein, the term “depth” generally refers to the thickness of a length of sealing/coating composition of the various embodiments described herein applied to a substrate (e.g., an automotive part or body part, including a windshield assembly or at least a portion of an automotive windshield assembly, a truck, a door, a deck lid, a hood, a lift age, a tail gate, and a rear body panel), measured orthogonally to the surface of the substrate onto which the composition is applied. For example, auto body parts require application of a seam sealer to protect/prevent intrusion of water, air, dust, fumes between two or more joined parts. These parts can include but are not limited to the following examples: door, fender, quarter panel, hood, deck lid, roof, floor, rocker panel, wheel house, cowl and frame/structural members. Additionally, exterior portions of auto body panels that may use materials such as a chip resistant coating/seam sealer applied using a sprayed method such as doors, fenders, quarter panels, rocker panels.

Light-curable acrylate systems are particularly advantageous because they provide a robust fast cure feature that is not affected by humidity or other environmental conditions and have corrosion-prevention properties that are advantageous in applications in, among other areas, as compositions in the automotive industry.

Suitable urethane acrylate components for use in the compositions include aliphatic urethane acrylates and aromatic urethane acrylates. In some embodiments, the urethane acrylates can be mono-acrylates or multi-functional urethane acrylates, including di-acrylates, tri-acrylates or mixtures of mono-, di-, and/or tri-acrylates.

Examples of suitable urethane acrylates include, but are not limited to oligomers and prepolymers including aliphatic urethane acrylates, commercial examples of which include those from Cytec Surface Specialties under the trademark EBECRYL and designations 244, 264, 265, 284N, 1290, 4833, 4866, 8210, 8301, 8402, 8405, 8807, 5129, and 8411; those available from Sartomer under the designations, CN 973H85, CN 985B88, CN 964, CN 944B85, CN 963B80, CN 973J75, CN 973H85, CN 929, CN 996, CN 966J75, CN 968, CN 980, CN 981, CN 982B88, CN 982B90, CN 983, CN991; CN 2920, CN 2921, CN 2922, CN 9001, CN 9005, CN 9006, CN 9007, CN 9009, CN 9010, CN 9031, CN 9782; GENOMER 4215, 1122, 4267, 4302, and 4316 and UA 00-022 available from Rahn; PHOTOMER 6892 and 6008 available from Cognis; NK OLIGO U24A and U-15HA available from Kowa. Additional urethane acrylates include the BR series of aliphatic urethane acrylates such as BR 144 or 970 available from Bomar Specialties or the LAROMER series of aliphatic urethane acrylates such as LAROMER LR 8987 from BASF.

Suitable urethane acrylate components for use in the compositions also include, but are not limited to those known by the trade designations: PHOTOMER (for example, PHOTOMER 6010 from Henkel Corp. of Hoboken, N.J.; EBECRYL (for example, EBECRYL 220 (a hexafunctional aromatic urethane acrylate of molecular weight 1000), EBECRYL 284 (aliphatic urethane diacrylate of 1200 grams/mole molecular weight diluted with 1,6-hexanediol diacrylate), EBECRYL 4827 (aromatic urethane diacrylate of 1600 grams/mole molecular weight), EBECRYL 4830 (aliphatic urethane diacrylate of 1200 grams/mole molecular weight diluted with tetraethylene glycol diacrylate), EBECRYL 6602 (trifunctional aromatic urethane acrylate of 1300 grams/mole molecular weight diluted with trimethylolpropane ethoxy triacrylate), and EBECRYL 840 (aliphatic urethane diacrylate of 1000 grams/mole molecular weight)) from UCB Radcure of Smyrna, Ga.; SARTOMER (for example, SARTOMER 9635, 9645, 9655, 963-B80, and 966-A80) from Sartomer Co., West Chester, Pa.; and UVITHANE (for example, UVITHANE 782) from Morton International, Chicago, Ill.

Suitable urethane acrylate components for use in the compositions also include, but are not limited to aliphatic urethane acrylates available from Soltech Ltd., Kyoungnam, Korea, such as SU 500 (aliphatic urethane diacrylate with isobornyl acrylate), SU 5020 (aliphatic urethane acrylate with butyl acetate), SU 5030 (aliphatic urethane acrylate with butyl acetate), SU 5039 (nona(9)-functional aliphatic urethane acrylate oligomer), SU 511 (aliphatic urethane diacrylate), SU 512 (aliphatic urethane diacrylate), SU 514 (aliphatic urethane diacrylate with hexane diol diacrylate (HDDA)), SU 591 (aliphatic urethane triacrylate with N-(2-hydroxypropyl) methacrylamide), SU 520 (deca(10)-functional aliphatic urethane acrylate), SU 522 (hexa-functional aliphatic urethane acrylate), SU 5225 (aliphatic urethane diacrylate with isobornyl acrylate), SU 522B (hexa-functional aliphatic urethane acrylate), SU 5260 (aliphatic urethane triacrylate), SU 5270 (aliphatic urethane diacrylate), SU 530 (aliphatic urethane diacrylate), SU 5347 (aliphatic urethane diacrylate), SU 542 (low viscosity aliphatic urethane diacrylate), SU 543 (low viscosity aliphatic urethane diacrylate), SU 564 (aliphatic urethane triacrylate with HDDA), SU 565 (aliphatic urethane triacrylate with tripropylene glycol diacrylate), SU 570 (aliphatic urethane diacrylate), SU 571 (hexa functional aliphatic urethane diacrylate), SU 574 (aliphatic urethane triacrylate with HDDA), SU 574B (aliphatic urethane triacrylate with HDDA), SU 580 (aliphatic urethane diacrylate), SU 584 (aliphatic urethane triacrylate with HDDA), SU 588 (aliphatic urethane triacrylate with 2-(2-ethoxyethoxy)ethyl acrylate), and SU 594 (aliphatic urethane triacrylate with HDDA).

Suitable urethane acrylate components for use in the compositions also include, but are not limited to aromatic urethane acrylates available from Soltech Ltd., Kyoungnam, Korea, such as SU 704 (aromatic urethane triacrylate with HDDA), SU 710 (aromatic urethane diacrylate), SU 720 (hexa-functional aromatic urethane acrylate), and SU 7206 (aromatic urethane triacrylate with trimethylolpropane triacrylate (TMPTA).

The urethane acrylate component is present in an amount of from about 5 wt. % to about 85 wt. %, from about 20 wt. % to about 45 wt. %, from about 30 wt. % to about 99.9 wt. %, from about 30 wt. % to about 65 wt. %, from about 40 wt. % to about 50 wt. %, from about 45 wt. % to about 55 wt. % or about from about 50 wt. % to about 60 wt. % of the total weight of the composition.

Suitable long alkyl chain (meth)acrylates for use in the compositions also include, but are not limited to saturated or unsaturated, substituted or unsubstituted long alkyl chain (meth)acrylates, such as C₆-C₁₈-acrylates including isooctyl acrylate, stearyl acrylate, and lauryl acrylate; The long alkyl chain (meth)acrylates can be present in an amount of from about 0.5 wt. % to about 10 wt. %,

Suitable fluorinated (meth)acrylates for use in the compositions also include, but are not limited to heptafluorobutyl methacrylate (HFBMA), Fluorinated butyl sulfonamide ethyl methacrylate; The fluorinated (meth)acrylates can be present in an amount of from about 0.5 wt. % to about 10 wt. %,

Suitable photoinitiators for use in the compositions include, photoinitiators having absorption at greater than 400 nm and an extinction coefficient of from about 10 to about 2000 L/mol·cm (e.g., about 50 to about 500 L/mol·cm or about 100 to about 700 L/mol·cm) at a wavelength from about 400 nm to about 500 nm.

Examples of suitable photoinitiators having absorption at greater than 400 nm for use in the compositions include, but are not limited to quinones, phosphine oxides, phosphinates, mixtures thereof and the like. Photoinitiators include camphorquinone (CPQ), and phosphine oxides available from BASF under LUCIRIN TPO, LUCIRIN TPO-L, LUCIRIN TPO-XL, or IRGACURE 819, IRGACURE 2100 from Ciba, mixtures thereof. In some embodiments, the photoinitiator is

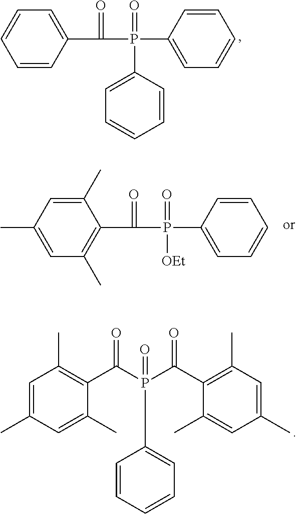

The examples of photoinitiators for use in the compositions also include, but are not limited to the combination of the photoinitiators having absorption at greater than 400 nm (e.g., listed in [0099) and the photoinitiators having absorption at less than 400 nm (e.g., alpha aminoketones, benzophenones, alpha hydroxyketones 1-hydroxycyclohexyl-phenylketone available from Ciba Geigy under IRGACURE 184, oligomeric alpha hydroxyketones, such as ESACURE ONE or KIP 150 from Lamberti, 2-benzyl 2-N-dimethylamino-1-(4-morpholinophenyl)-1-butanone available from Ciba Geigy under IRGACURE 369, IRGACURE 379). Other examples such as SARCURE and SR 1135 from Sartomer or ESCACURE KTO 46 or TZT from Lamberti, which is a mixture of an alpha hydroxy ketone benzophenone derivatives and a phosphine oxide, and the like.

Examples of suitable photoinitiators having absorption at greater than 400 nm for use in the compositions include, but are not limited to quinones, coumarins, phosphine oxides, phosphinates, mixtures thereof and the like. Photoinitiators include camphorquinone (CPQ), and phosphine oxides available from IGM Resins USA Inc. (Charlotte, N.C.) under the OMNIRAD trade designation; specifically, ethyl-2,4,6-trimethylbenzoylphenyl phosphinate (e.g., available as OMNIRAD TPO-L), 2,4,6-trimethylbenzoyl-diphenyl-phosphine oxide (e.g., available as OMNIRAD TPO), and bis-(2,4,6-trimethylbenzoyl)-phenylphosphine oxide (e.g., available as OMNIRAD 819 from IGM Resins USA Inc.).

Photoinitiators having absorption at less than 400 nm (e.g. alpha aminoketones, benzophenones, alpha-hydroxyketones 1-hydroxycyclohexyl-phenylketone available from IGM Resins USA Inc. (Charlotte, N.C.)). Examples of photoinitiators that have an absorption less than 400 nm include benzoin ethers such as benzil dimethyl ketal (e.g., available as OMNIRAD 651), benzoin methyl ether, benzoin ethyl ether, benzoin n-butyl ether; acetophenone and its derivatives such as 2-hydroxy-2-methyl-1-phenyl-1-propanone (e.g., available as OMNIRAD 1173), 1-hydroxycyclohexyl phenyl ketone (e.g., available as OMNIRAD 184) and oligo[2-hydroxy-2-methyl-1[4-(1-methylvinyl) phenyl]propanone] (e.g., available as ESACURE KIP 150 or ESACURE ONE); 2-methyl-1[4-(methylthio)phenyl]-2-(4-morpholinyl)-1-propanone (e.g., available as OMNIRAD 907); 2-benzyl-2-(dimethylamino)-1-[4-(4-morpholinyl)phenyl]-1-butanone (e.g., available as OMNIRAD 369)

The photoinitiator can be present in an amount of about 0.1, about 1, about 2, about 4, about 6, about 8 or about 10 parts by weight or greater based on the weight of the composition. The photoinitiator(s) can be present in an amount of from about 0.1 wt. % to about 10 wt. %, about 0.1 wt. % to about 8 wt. %, about 3 wt. % to about 5 wt. %, about 2 wt. % to about 8 wt. %, from about 0.5 wt. % to about 10 wt. %, from about 0.5 wt. % to about 5 wt. %, from about 0.5 wt. % to about 2 wt. %, from about 1 wt. % to about 3 wt. % of the total weight of the composition. The photoinitiator(s) can be present in about 2 wt. %.

Suitable one or more fillers for use in the compositions include, but are not limited to alumina (e.g., alpha alumina), silica (e.g., fumed, such as CAB-O-SIL TS-720 and TS-710 or fused, Cabot Corp., Billerica, Ma.), glass bubbles (e.g., 3M glass bubbles for resin systems), glass flakes, glass beads, polymeric spheres, mica, kaolin, talc, barium sulfate, carbides, potassium sulfate, calcium carbonate (including surface-modified calcium carbonate), zinc oxide, silicates, clay, titanium dioxide, zirconia, boron carbide, silicon carbide, cerium oxide, glass, wollastonite, diamond, aluminum nitride, silicon nitride, yttrium oxide, titanium diboride, metallic salts of fatty acids, or any combination thereof. Other fillers may be employed, such as those described in U.S. Pat. No. 7,781,493, which is incorporated by reference as if fully set forth herein. In some embodiments, fillers may contain surface hydroxyls, have a particle size of about 10 microns or less or 5 microns or less, or both. The filler is present in an amount of from about 0.1 wt. % to about 70 wt. %, about 1 wt. % to about 70 wt. %, about 0.1 wt. % to about 20 wt. %, about 1 wt. % to about 30 wt. %, from about 1 wt. % to about 25 wt. %, from about 1 wt. % to about 15 wt. %, from about 1 wt. % to about 10 wt. %, from about 0.1 wt. % to about 20 wt. %, from about 1 wt. % to about 3 wt. %, from about 5 wt. % to about 7 wt. %, or about from about 2 wt. % to about 6 wt. % of the total weight of the composition.

Suitable one or more monothiols include, but are not limited to 1-ethanethiol, 1-propanethiol, 3-propanethiol, 3-butanethiol, 1-butanethiol, 2-butanethiol, 3-pentanethiol, 1-pentanethiol, 1-hexanethiol, 1-mercapto-3-methylbutane, and a combination of any of the foregoing. A monothiol may have one or more pendant groups selected from an alkyl group, an alkoxy group, and a hydroxyl group. Other suitable monothiols include those of the formula (I):

R¹—SH

wherein R¹ is (CH₃)—(CH₂)ᵣ—X¹—(CH₂)ᵣ—, wherein r is an integer from 0 to 4 and X¹ is —O—, —S— or C(R²)₂, wherein R² is H or (C₁-C₆) alkyl. Examples of compounds encompassed by formula (I) include, for example, CH₃CH(—CH₃)—S—CH₂CH₂—SH, CH₃CH₂CH₂—SCH₂CH₂—SH, CH₃CH(—CH₃)—S—CH(CH₃)CH₂—SH and CH₃CH₂CH₂—S—CH₂CH(CH₃)—SH.

Suitable one or more polythiols include, but are not limited to dithiols, trithiols, and tetrathiols.

Examples of dithiols include, but are not limited to, 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethylsulfide, methyl-substituted dimercaptodiethylsulfide, dimethyl-substituted dimercaptodiethylsulfide, dimercaptodioxaoctane, 1,5-dimercapto-3-oxapentane, and a combination of any of the foregoing. A polythiol may have one or more pendant groups selected from an alkyl group, an alkoxy group, and a hydroxyl group. Other suitable dithiols include those of the formula (II):

HS—R³—SH

wherein R³ is —[(—CH₂—)ₛ—X²—]_{q}—(CH₂)ᵣ—, wherein s is an integer from 1 to 4, r is an integer from 1 to 4, q is an integer from 1 to 3, and X is —O— or —S—). Examples of compounds encompassed by formula (I) include dimercaptodiethylsulfide (DMDS); dimercaptodioxaoctane (DMDO); and 1,5-dimercapto-3-oxapentane. Other compounds encompassed by the formula (I) include, for example, methyl-substituted DMDS, such as HS—CH₂CH(—CH₃)—S—CH₂CH₂—SH, HS—CH(—CH₃)CH₂—SCH₂CH₂—SH and dimethyl substituted DMDS, such as HS—CH₂CH(—CH₃)—S—CH(CH₃)CH₂—SH and HS—CH(CH₃)CH₂—S—CH₂CH(CH₃)—SH. It is also possible to use dithiols wherein X is —O— and —S— and pendant alkyl groups.

Examples of trithiols include, but are not limited to, 3,6-dimercaptomethyl-1,9-dimercapto-2,5,8-trithianonane, 1,2,9-trimercapto-4,6,8-trithianonane, 3,7-dimercaptomethyl-1,9-dimercapto-2,5,8-trithianonane, 4,6-dimercaptomethyl-1,9-dimercapto-2,5,8-trithianonane, 1,4,8,11-tetramercapto-2,6,10-trithiaundecane, and combinations thereof.

Examples of treatrathiols include, but are not limited to, 1,4,9,12-tetramercapto-2,6,7,11-tetrathiadodecane, 1,4,9,12-tetramercapto-2,6,7,11-tetrathiadodecane, 2,3,5,6-tetrathia-1,7-heptanedithiol, and combinations thereof.

Aromatic polythiols are also contemplated. Examples of aromatic polythiols include, but are not limited to, 1,2-dimercaptobenzene, 1,3-dimercaptobenzene, 1,4-dimercaptobenzene, 1,2-bis(mercaptomethyl)benzene, 1,3-bis(mercaptomethyl)benzene, 1,4-bis(mercaptomethyl)-benzene, 1,2-bis(mercaptoethyl)benzene, 1,3-bis(mercaptoethyl)benzene, 1,4-bis(mercaptoethyl)-benzene, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(mercaptoethyl)benzene, 1,2,4-tris(mercaptoethyl)benzene, 1,3,5-tris(mercaptoethyl)benzene, 2,5-toluenedithiol, 3,4-toluenedithiol, 1,3-di(p-methoxyphenyl)propane-2,2-dithiol, 1,3-diphenylpropane-2,2-dithiol, phenylmethane-1,1-dithiol and 2,4-di(p-mercaptophenyl)pentane, and combinations thereof.

In some embodiments, thiols are included in the compositions of the various embodiments described herein in an amount such that the ratio of thiol functionality to acrylate functionality in the urethane acrylate component is 3:10; 2:10; or 1:10 thiol to acrylate.

Suitable one or more plasticizers for use in the compositions include, but are not limited to plasticizers having a broad range of molecular weights and architectures. The plasticizers may be polymeric or monomeric. Small molecule plasticizers are typically derived from mono- or multi-functional, low molecular weight acids or alcohols that are esterified with a mono-functional alcohol or mono-functional acid, respectively. Common among these monomeric plasticizers are esters of mono- or di-basic acids such as myristate esters, phthalate esters, adipate esters, phosphate esters, citrates, trimellitates, glutarates, and sebacate esters (e.g., dialkyl phthalates, such as dibutyl phthalate, diisoctyl phthalate, dibutyl adipate, dioctyl adipate; 2-ethylhexyl diphenyl diphosphate; t-butylphenyl diphenyl phosphate; butyl benzylphthalates; dibutoxyethoxyethyl adipate; dibutoxypropoxypropyl adipate; acetyltri-n-butyl citrate; dibutylsebacate; etc.). Phosphate ester plasticizers are commercially sold under the trade designation SANTICIZER from Monsanto; St. Louis, Mo. Glutarate plasticizers are commercially sold under the trade designation PLASTHALL 7050 from Hallstar; Chicago, Ill. Suitable plasticizers also include PLASTHALL 190.

Suitable one or more adhesion promoters for use in the compositions include, but are not limited to acid-functional monomers such as acrylic acid (AA), methacrylic acid (MAA), beta-carboxyethyl acrylate (B-CEA) and 2-hydroxy ethyl methacrylate (HEMA) phosphate and 2-hydroxy ethyl methacrylate (HEMA) succinate, (meth)acrylic phosphonic acids and esters (e.g., phosphonic urethane methacrylate (PUM)); vinyl phosphonic acid, thioglycolic acid, mercaptosuccinic acid, thiolactic acid, 8-Mercaptooctanoic acid. Suitable one or more adhesion promoters for use in the compositions also include, but not limited to hydroxyl functional monomers, 2-hydroxy ethyl methacrylate (HEMA), 2-hydroxy ethyl acrylate (HEA), CN131B, 4-Mercapto-1-butanol, 4-Mercaptophenol, 2-Mercaptoethanol; Suitable one or more adhesion promoters for use in the compositions also include silane functional monomers, including (3-acryloxypropyl)trimethoxysilane, methacryloxypropyltrimethoxysilane, N-(3-acryloxy-2-hydropropyl)-3-aminopropyltriethoxysilane, (3-acryloxypropyl)methyldimethoxysilane, (methacryloxymethyl)methyldiethoxysilane, methacryloxypropyldimethylethoxysilane, methacryloxypropyldimethylmethoxysilane, and (3-Mercaptopropyl)trimethoxysilane, all of which are available from Gelest, Inc., Morrisville, Pa. Other suitable one or more adhesion promoters include, but not limited to nitrogen-containing functional monomers such as N-vinyl-caprolactam, N,N-dimethyl acrylamide, acrylamide, acrylonitrile, N-tert-butylacrylamide, 2-tert-butylaminoethyl methacrylate, diethylaminoethyl methacrylate, dimethylaminoethyl methacrylate, N-isopropylacrylamide, methacrylonitrile, vinyl carbazole, 2-vinylpyridine, 4-vinylpyridine, and 1-vinyl-2-pyrrolidone, cysteamine, 4-ethyl-4H-1,2,4-triazole-3-thiol, N-carbamoyl-L-cysteine. The adhesion promoter is present in an amount of from about 3 wt. % to about 50 wt. %, about 3 wt. % to about 10 wt. %, about 5 wt. % to about 20 wt. %, 10 wt. % to about 30 wt. %, from about 15 wt. % to about 40 wt. %, from about 1 wt. % to about 15 wt. %, from about 1 wt. % to about 10 wt. %, from about 0.1 wt. % to about 20 wt. %, from about 25 wt. % to about 50 wt. %, or from about 15 wt. % to about 30 wt. % of the total weight of the composition.

Suitable one or more diluents for use in the compositions include, but are not limited to reactive and non-reactive diluents. Examples of reactive diluents include monomers including monoacrylates such as phenylthio ethyl(meth)acrylate, isooctyl acrylate (e.g., commercially available as SR-440 from Sartomer, Exton, Pa.), isodecyl acrylate (e.g., commercially available as SR-395 from Sartomer), isobornyl acrylate (e.g., commercially available as SR-506 from Sartomer), 2-phenoxyethyl acrylate (e.g., commercially available as SR-339 from Sartomer), alkoxylated tetrahydrofurfuryl acrylate (e.g., commercially available as CD-611 from Sartomer), and 2(2-ethoxyethoxy)ethylacrylate (e.g., commercially available as SR-256 from Sartomer); diacrylates such as 1,3-butylene glycol diacrylate (e.g., commercially available as SR-212 from Sartomer), 1,6-hexanediol diacrylate (e.g., commercially available as SR-238 from Sartomer), neopentyl glycol diacrylate (e.g., commercially available as SR-247 from Sartomer), and diethylene glycol diacrylate (e.g., commercially available as SR-230 from Sartomer). Other reactive diluent monomers include, for example, methyl styrene, styrene, divnyl benzene, and the like, as well as low viscosity acrylate monomers such as GENOMER 1122, aliphatic urethane monoacrylate (CAS: 63225-53-6), CN131B. and SR339. The diluent is present in an amount of from about 1 wt. % to about 80 wt. %, about 10 wt. % to about 80 wt. % about 1 wt. % to about 70 wt. %, 0.1 wt. % to about 20 wt. %, 1 wt. % to about 30 wt. %, from about 1 wt. % to about 25 wt. %, from about 1 wt. % to about 15 wt. %, from about 1 wt. % to about 10 wt. %, from about 0.1 wt. % to about 20 wt. %, from about 25 wt. % to about 50 wt. %, from about 25 wt. % to about 40 wt. %, or about from about 25 wt. % to about 60 wt. % of the total weight of the composition.

It should be understood that certain components described herein can act as non-reactive diluents, including plasticizers and fillers and combinations thereof. Tackifiers can also act as non-reactive diluents, including hydrogenated rosins and synthetic hydrocarbon resins. The compositions of the various embodiments described herein can further comprise any number of additives as desired. Examples of suitable additives include, photosensitizers (e.g., camphorquinone, coumarin photosensitizers such as (7-ethoxy-4-methylcoumarin-3-yl)phenyliodonium hexafluoroantimonate, (7-ethoxy-4-methylcoumarin-6-yl)]phenyliodonium hexafluoroantimonate, (7-ethoxy-4-methylcoumarin-3-yl)phenyliodonium hexafluorophosphate, (7-ethoxy-4-methylcoumarin-6-yl)]phenyliodonium hexafluorophosphate, such as those described in Ortyl and Popielarz, Polimery 57: 510-517 (2012), which is incorporated by reference as if fully set forth herein; 1,3-dioxane methyl couramin, such as is described in Yin et al., Journal of Applied Polymer Science 125: 2371-2371 (2012), which is incorporated by reference as if fully set forth herein; coumarin dye; and ketocoumarin dye). Photosensitizers, when present, can be present in an amount of from about 0.0001 wt. % to about 5 wt. % (e.g., from about 0.0001 wt. % to about 0.02 wt. %, 0.5 wt. % to about 1 wt. %, about 1 wt. % to about 3 wt. % or about 0.05 wt. % to about 0.5 wt. %).

Examples of suitable additives include, photobleaching dyes/agents (e.g., Rose Bengal, Methylene Violet, Methylene Blue, Fluorescein, Eosin Yellow, 65 Eosin Y, Ethyl Eosin, Eosin bluish, Eosin B, Erythrosin B, Erythrosin Yellowish Blend, Toluidine Blue, Disperse blue 60, oil blue A, 4′,5′-Dibromofluorescein and blends thereof). Photobleaching dyes/agents, when present, can be present in an amount of from about 0.0001 wt. % to about 5 wt. % (e.g., from about 0.0001 wt. % to about 0.02 wt. %, 0.5 wt. % to about 1 wt. %, about 1 wt. % to about 3 wt. % or about 0.05 wt. % to about 0.5 wt. %).

Examples of suitable additives include, corrosion inhibitors (e.g., primary, secondary and tertiary aliphatic amines; aliphatic diamines; cycloaliphatic and aromatic amines; polymethylimines; long alkyl chain ethanolamines; imidazolines; amine-epoxy adduct solids, such as FXR1020, Ancamine 2442, FXR 1080, amine salts of an aromatic sulfonic acid, NACORR 1754, for example those of carbonic, carbamic, acetic, benzoic, oleic, nitrous and chromic acids; acetylenic alcohols; lauric alcohol; alkyl chromates; organic esters of nitrous acid; organic esters of phthalic acid; organic esters of carbonic acid; nitronaphthalene; nitrobenzene; amides; mixtures of nitrites with urea, urotropine, or ethanolamines; naphthols; thiourea derivatives; heterocyclic compounds such as benzotriazole, tolyltriazole, mercaptobenzothiazole and their respective salts; nitrated or sulfonated petroleum derivatives; and Zinc phosphate complex LUBRIZOL 219, dodecenyl succinic acid LUBRIZOL 541). Corrosion inhibitors, when present, can be present in an amount of from about 0.5 wt. % to about 10 wt. % (e.g., from about 1 wt. % to about 5 wt. %).

Examples of suitable additives include, pigments, surfactants, thixotropic agents, fire retardants, masking agents, and combinations of any of the foregoing. When used, the additives may be present in a composition in an amount ranging, for example, from about 0% to 20% by weight.

The compositions of the various embodiments described herein can be polymerized/cured by any suitable method, including photochemically. In one embodiment, the compositions of the various embodiments described herein can be polymerized/cured using a light-emitting curing device emitting light at a wavelength of from about 260 nm to about 550 nm (e.g., from about 400 nm to about 500 nm; about 425 nm to about 475 nm; or about 440 nm to about 460 nm) and having a radiometric energy of about at least about 0.1 W/cm² (e.g., about 0.5 W/cm² to about 5 W/cm²; about 1 W/cm² to about 3 W/cm²; about 1 W/cm² to about 2 W/cm²; or about 0.5 W/cm² to about 2 W/cm²).

It should be understood that any suitable light-emitting curing device emitting light at a wavelength of from about 260 nm to about 550 nm and having a radiometric energy of about at least about 0.1 W/cm² can be used to polymerize/cure the compositions of the various embodiments described herein. In some embodiments, a suitable light-emitting curing device can use light emitting diodes (LEDs), but need not be limited to light-emitting curing devices based on LEDs. But any suitable source of light of wavelength of from about 260 nm to about 550 nm and having a radiometric energy of about at least about 0.1 W/cm² can be used.

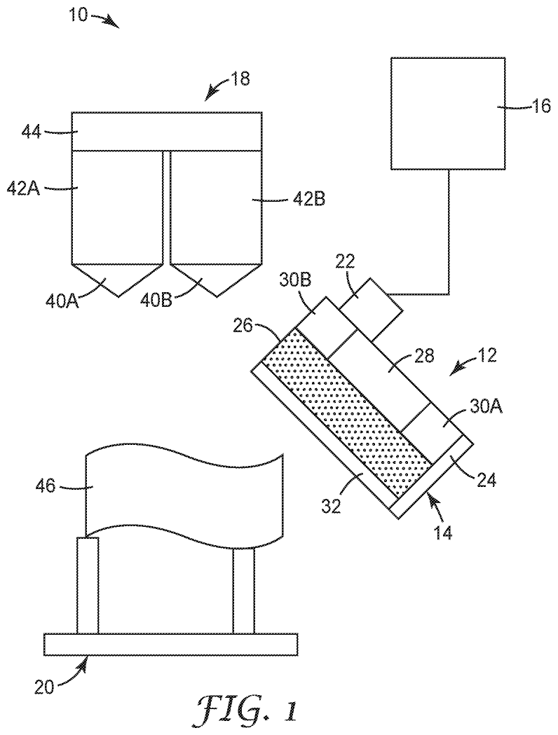

FIG. 1 is a schematic view of a sealing system 10 including curing head 12 of the present disclosure including an air-cooled, light-emitting curing device 14. Sealant system 10 can also include system controller 16, dispensing device 18 and jig 20. Curing head 12 can also include controller 22 and sensor system 24 (optional). Light-emitting curing device 14 can also include light-emitter 26, heat sink 28, fans 30A and 30B and lens 32. Dispensing device 18 can include first nozzle 40A, first container 42A, second nozzle 40B, second container 40B and controller 44. Sealing system 10 can be used to apply and cure a composition on object 46.

Jig 20 can be used to support object 46 during dispensing and curing operations. Dispensing device 18 can be used to apply a liquid material to object 46. Subsequently, curing device 14 can be used to cure the liquid material dispensed by dispensing device 18. System controller 16 can be connected to curing controller 22 and dispenser controller 44 in order to coordinate operations of curing device 14 and dispensing device 18.

Jig 20 can comprise any suitable device for holding object 46. Jig 20 can be configured to hold object 46 in a stationary manner with a side or sides of object 46 facing toward dispensing device 18 and curing device 14. In various examples, jig 20 can be configured to rotate or move object 46 in multiple directions to orient object 46 relative to dispensing device 18 and curing device 14 using any suitable means. In additional examples, dispensing device 18 and curing device 14 can be attached to robotic arms and can be configured to move relative to jig 20 and object 46 to provide complete sealant and curing coverage to object 46. Also, dispensing device 18 and curing device 14 can be manually positioned and operated devices.

The light-emitting curing device 14 can be held at any suitable distance from object 46, even in direct contact with a composition that is dispensed onto the object 46. In some embodiments, the distance between the light-emitting curing device 14 and a composition that is dispensed onto the object 46 can be optimized such that the intensity of light that is dispensed from light-emitting curing device 14 is maximized and/or the curing time of a composition that is dispensed onto the object 46 is minimized (e.g., minimized to from about 0.5 second to about two minutes).

In an example, object 46 can comprise a substrate, such as an automotive body part requiring sealing, and dispensing device 18 can be configured to apply a multi-component composition to the part. Although, system 10 can be used to apply any of the compositions of the various embodiments described herein to any object. In an example, the material dispensed by dispensing device 18 can comprise composition of the various embodiments described herein, including one or more fillers, one or more thiols, one or more plasticizers, one or more one or more adhesion promoters, and one or more diluents.

In an example, components of the composition can be individually loaded into containers 40A and 40B and dispensed from nozzles 42A and 42B, respectively. Thus, the components can become mixed and entrained while in transit from nozzles 42A and 42B to object 46. In other examples, the components of the composition can be pre-mixed and dispensed using only a single storage container and nozzle. In embodiments, dispensing device 18 can be automatically controlled. That is, nozzles 40A and 40B can be configured to open on demand by a signal generated from controller 44. Controller 44 can be configured to open and close valves within dispensing device 18. In other examples, dispensing device 18 can comprise a hand-held, manually operated device, such as something akin to a caulking gun or a syringe-type device.

Curing device 14 can be used to treat material dispensed by dispensing device 18. In an example, curing device 14 can be used to cure a composition by subjecting the composition to light of a particular wavelength and intensity using emitter 26. In an example, emitter 26 can comprise one or more light emitting diodes (LEDs). Specifically, emitter 26 can comprise an array of LEDs arranged to provide a wide swath of light in a consistent or uniform manner while also providing spacing that permits effective cooling. Lens 32 can be positioned in front of emitter 26, e.g., between object 46 and emitter 26, in order to condition or alter light waves emanating from emitter 26, as discussed herein. However, lens 32 can be configured as a transparent plate so as to not alter light waves from emitter 26.

In order to dissipate heat generated by emitter 26, heat sink 28 can be positioned adjacent emitter 26. In an example, heat sink 28 can be positioned behind emitter 26, e.g., away from the direction of object 46. In an example, heat sink 28 can comprise a plurality of fins to draw heat away from emitter 26 and increase a surface area from which the heat can dissipate. Fans 30A and 30B can be used to further remove heat from emitter 26. For example, fans 30A and 30B can be used to push air past fins of heat sink 28.

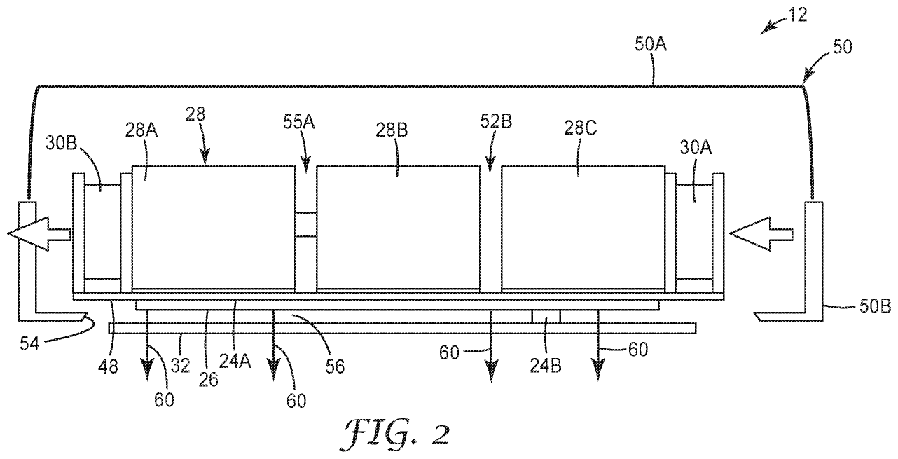

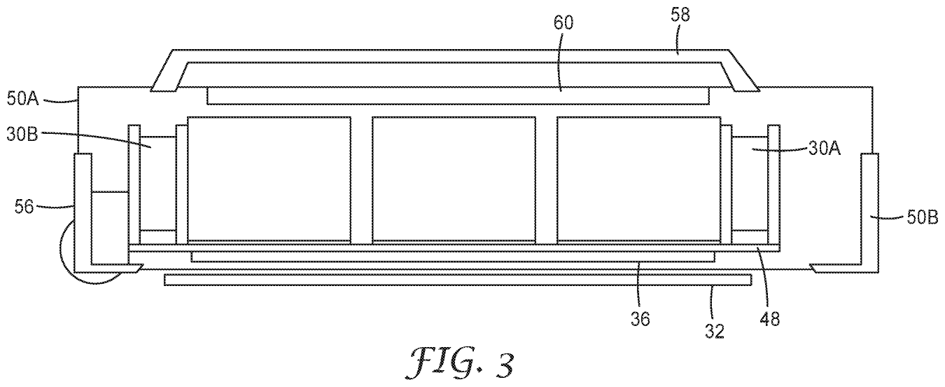

Curing head 12 can include sensor system 24 that can be used to control operation of curing device 14. In various examples, sensor system 24 can comprise a temperature sensor to monitor the temperature of emitter 26. Controller 22 can monitor an output signal of sensor system 24 to, for example, adjust the operation of fans 30A and 30B to increase or decrease the amount of airflow applied to emitter 26 and/or the 28. Other cooling methods are contemplated, including heat pipes, or liquid cooling technology. Controller 22 can also adjust the intensity or brightness of light originating from emitter 26, such as by controlling power delivered to emitter 26. Heat sink 28, sensor system 24 and other components and accessories of curing head 12 can be configured in different arrangements and combinations in other embodiments, such as those shown in FIGS. 2 and 3.

FIG. 2 is a schematic cross-sectional view of an embodiment of curing head 12 of FIG. 1 configured as a hand-held “wand” wherein emitter 26 comprises an elongate bank of light emitting diodes. Curing head 12 can include chassis 48 and housing 50 having upper housing component 50A and lower housing component 50B. Sensor system 24 can include lens sensor 24A and heat sink sensor 24B. Heat sink 28 can include heat sink banks 28A, 28B and 28C, and cross slots 52A and 52B.

Housing 50 can be configured to contain elements of curing head 12 in a self-contained package that can, for example, be a hand-held device. Housing 50 can be configured to open such as by separating upper housing component 50A from lower housing component 50B. Housing components 50A and 50B can be held together by any suitable means, such as by means that permit components 50A and 50B to be releasably coupled together for repeated opening and closing. Lower housing component 50B can comprise opening 54. Lens 32 can be positioned adjacent opening 54. Chassis 48 can be mounted to lower housing component 50B, and emitter 26 can be mounted to chassis 48 to face toward opening 54. Gaps can be positioned between opening 54 and lens 32, and emitter 26 can be positioned back a distance from opening 54 so that cooling channel 56 can be positioned through housing 50.

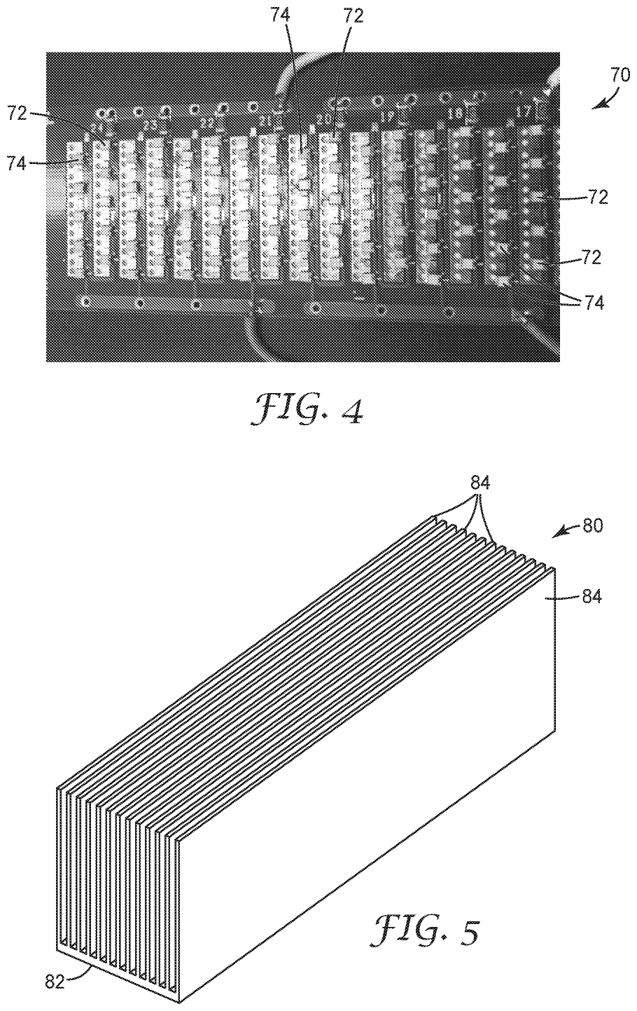

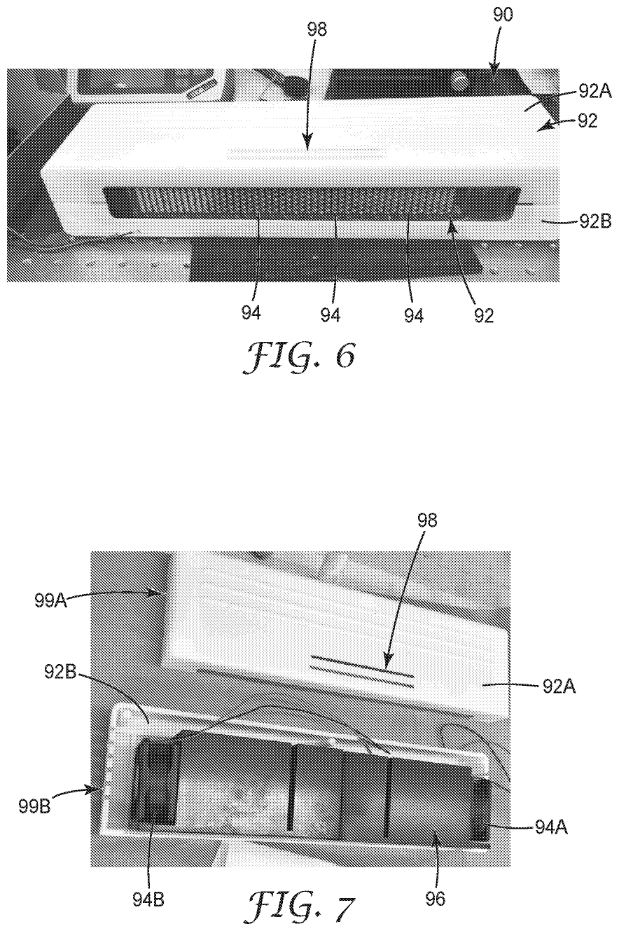

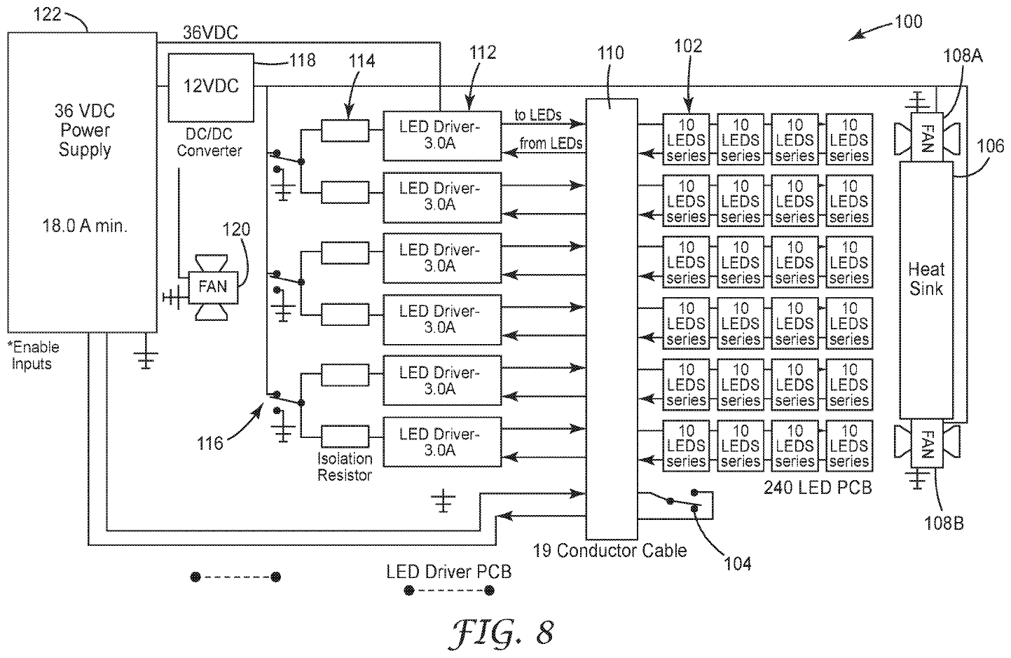

Heat sink banks 28A, 28B and 28C can be mounted to chassis 48 opposite emitter 26. More specifically, heat sink banks 28A-28C can be positioned on chassis 48 to be in direct or indirect thermal communication with emitter 26. As such, heat sink banks 28A-28C can draw heat away from emitter 26 either directly or indirectly through chassis 48. As discussed in greater detail with reference to FIG. 5, each of heat sink banks 28A-28C can comprise a plurality of plate-like fins. The fins can be oriented in a common direction through housing 50, such as the direction extending between fans 30A and 30B. Fans 30A and 30B can be positioned to push and or pull air through the fins to increase thermal transfer of heat away from emitter 26. As shown in FIG. 7, housing 50 can include vents to facilitate airflow through curing head 12.

In some embodiments, fans 30A and 30B can be mounted on chassis 48. Cross slots 52A and 52B can be positioned between heat sink bank 28A and 28B and 28B and 28C, respectively, to help reduce resistance of the airflow through heat sink 28. Cross slots 52A and 52B can comprise gaps in heat sink 28, such as between banks of plate-like fins. Sensor 24A can be positioned in cross slot 52A to sense the temperature in heat sink 28. Sensor 24B can be positioned in channel 56 to sense the temperature of emitter 26. Emitter 26, fans 30A and 30B and sensors 24A and 24B can be connected to controller 22 (FIG. 1), which can be located within housing 50. Fans 30A and 30B and sensors 24A and 24B can comprise any suitable type of fan device or sensor device, respectively, as is known in the art.

In operation, controller 22 can activate, or a button on controller 22 can be activated by an operator, to energize emitter 26 in order to generate light beams 60. In example embodiments, emitter 26 can comprise an array of LEDs. More specifically, emitter 26 can comprise a 5×5 array of LEDs emitting light at a wavelength of from about 260 nm to about 550 nm (e.g., from about 400 nm to about 500 nm; about 425 nm to about 475 nm; or about 440 nm to about 460 nm) and having a radiometric energy of about at least about 0.1 W/cm² (e.g., about 0.5 W/cm² to about 5 W/cm²; about 1 W/cm² to about 3 W/cm²; about 1 W/cm² to about 2 W/cm²; or about 0.5 W/cm² to about 2 W/cm²). Such an emitter can be used with a composition comprising at least a photoinitiator responsive to the wavelength of light emitted by the LED array. Curing times for such an LED array and the compositions of the various embodiments described herein can be about 0.5 second to about two minutes; about 1 second to about 5 seconds; about 1 second to about 10 seconds; about 5 seconds to about 30 seconds; about 30 seconds to about two minutes; or about 45 seconds to about 1.5 minutes.

In example wand configurations, such as that of FIG. 2, emitter 26 can include an elongate array of 240 LEDs. As discussed below with reference to FIG. 4, diodes of the array can be arranged in a staggered pattern. The staggering pattern can be configured such that a uniform, efficient, radiometrically intense, short wavelength photonic system can result, which can be useful for initiating curing reactions. The 240 LEDs can be driven by controller 22 at up to 2 W (˜2 J/sec) per LED, which can result in a 480 W (˜480 J/sec) electrical load. Various means can be used to dissipate thermal heat generated by the 240 LEDs. For example, if the 240 LEDs are approximately 40% efficient, the estimated thermal load can be approximately 480 W×0.6, which equals approximately 300 W (300 J/sec). Thus, fans 30A and 30B can be configured to remove a corresponding amount of heat.

In some embodiments, light beams 60 can pass through lens 32. Lens 32 can comprise a transparent plate, a Fresnel lens or an optical filter. Lens 32 can have edges that can be shaped or treated with filtering or reflective material to minimize photonic leakage. That is, the sides of lens 32 can be configured to recycle some of light beams 60 that would escape the sides of lens 32 and direct it through the planar faces of lens 32. In examples, a polyimide tape or a reflective film can be applied to the edges of lens 32. Lens 32 can comprise a hard material so as to be configured to protect emitter 26. Lens 32 can, by partially closing off opening 54, can cause turbulence within air flowing through housing 50 adjacent emitter 26 or heat sink assembly (not shown) to promote heat transfer.

Most of the heat from the LEDs can be conducted from the backside of emitter 26 by heat sink banks 28A-28C. Lens 32 can be used to aid in conducting air past emitter 26. Fans 30A and 30B can be configured to flow air from a first side of housing 50 to a second side of housing 50. As shown in FIG. 2, air can enter gap 54 near fan 30A, can be pushed through channel 56, and can be pulled through channel 56 by fan 30B. Lens 32 can be positioned relative to emitter 26 to increase turbulence. Fans 30A and 30B can also be positioned to push and pull air through heat sink banks 28A-28C. Cross slots 52A and 52B can assist in reducing resistance, or drag, of airflow through heat sink 28. Furthermore, a gap can be included between the upper surfaces of heat sink banks 28A-28C and upper housing component 50A to permit additional air mixing.

Sensors 24A and 24B can be operated by controller 22 to monitor the temperature in curing head 12. Controller 22 can thus adjust operation of fans 30A and 30B to adjust the temperature of emitter 26. Other types of sensors, such as power sensors and radiometric energy sensors, can be included in curing head 12. Output of sensors used with curing head 12 can be communicated to controller 22 or another control module using various wired or wireless connections.

FIG. 3 is a schematic cross-sectional view of an embodiment of curing head 12 of FIG. 1 configured as a “wand” wherein emitter 26 comprises an elongate bank of light emitting diodes and curing head 12 additionally includes LED spotlight 56. Features of the embodiments of curing head 12 shown in FIGS. 2 and 3 can be combined in any desirable permutation.

In some embodiments, curing head 12 of FIG. 3 can include the same components as curing head 12 of FIG. 2 with the addition of LED spotlight 56, handle 58 and insulation 60. LED spotlight 56 can comprise an additional array of LEDs to provide an additional light beam for curing or illuminating purposes. LED spotlight 56 can be positioned to emit light at an angle to the primary direction that emitter 26 emits light beams 60. LED spotlight 56 can be used to provide spot curing of a composition, such as to provide touch-up work, with emitter 26 powered off.

Handle 58 can be connected to upper housing component 50A to facilitate manual operation of curing head 12. For example, handle 58 can comprise an elongate bar that an operator of curing head 12 can grasp to manipulate curing head 12. Insulation 60 can be positioned in upper housing component 50A between heat sink banks 28A-28C and handle 58 in order to insulate, or thermally separate, handle 58 from heat dissipated by heat sink banks 28A-28C.

FIG. 4 is a close-up view of light emitting diode array 70 having staggered LEDs 72 and 74. LEDs 72 and 74 can be arranged in alternating columns (with respect to the orientation of FIG. 4) where rows of LEDs 72 and 74 in each column are offset from each other. Thus, LEDs 72 are offset by a particular pitch defined as the gap, in millimeters, between each individual LED 72. In addition, LEDs 72 are displaced higher than LEDs 74 in a vertical direction (with respect to the orientation of FIG. 4) and the distance between each of LEDs 72 and/or each of LEDs 74 is from about 1.5 mm to about 12 mm (e.g., 1.5 mm to about 3 mm; 2 mm to about 6 mm; 1.5 mm to about 4 mm; or about 3 mm to about 5 mm). Staggering of LEDs 72 and 74 can optimize light coverage provided by array 70 for curing purposes, such as by providing an overall light emission that has consistent intensity throughout. This can be useful in curing compositions in a uniform and expedient manner. Staggering can also permit cooling air to uniformly pass between each LED, thereby improving cooling efficiency. Staggering of LEDs 72 and 74 can permit the quantity of LEDs to be scaled up or down while maintaining uniformity as well as spacing that is conducive to cooling.

In some embodiments, the LEDs 72 are arranged in a plurality of columns, each column comprising a plurality of light emitting diodes having a pitch within each column of from about 1.5 mm to about 12 mm (e.g., 1.5 mm to about 3 mm; 2 mm to about 6 mm; 1.5 mm to about 4 mm; or about 3 mm to about 5 mm).

Although the LEDs shown in FIG. 4 do not comprise lenses or optics, in some embodiments, the LEDs can have lenses or other optics.

FIG. 5 is a perspective view of an example heat sink 80 that can be used in curing heads 14 of FIGS. 2 and 3. Heat sink 80 can include base 82 and fins 84. Base 82 can comprise a plate or other structure that can permit fins 84 to be mounted to a structure, such as emitter 26 or chassis 48 (FIG. 2). Fins 84 can comprise rectilinear plates having first ends connected to base 82 and second ends cantilevered away from base 82. Fins 84 can thus be configured to draw heat away from base 82, which can be positioned to be in thermal communication with array 26. In an example, fins 84 can be fabricated from aluminum.

FIG. 6 is a perspective view of curing head 90 of the present disclosure having housing 92 in which an array 94 of light emitting diodes 94 is located. Housing 92 can include upper housing component 92A and lower housing component 92B. Upper and lower housing components 92A and 92B can have an elongate, wand-like form factor in order to provide a wide emission of light that can be waved or moved across narrower strips of composition, such as along the edge of a windshield.

FIG. 7 is a perspective view of curing head 90 of FIG. 6 showing housing 92 partially exploded to expose fans 94A and 94B positioned on opposite sides of heat sink 96. Upper and lower housing components 92A and 92B can be connected by any suitable means, such as threaded fasteners or snap couplings. Upper housing component 92A and lower housing component 92B can come together to form opening 97 to permit light from light emitting diodes 94 to escape. Opening 97 can be covered with a lens or plate.

Upper and lower housing components 92A and 92B can include various features to promote airflow through housing 92. For example, upper housing component 92A can include vents 98, which can comprise openings through upper housing component 92A that permit heat and air to escape from housing 92. Also, upper housing component 92A and lower housing component 92B can include side vents, such as vents 99A and 99B, respectively, that come together to form vent 99. A corresponding vent can be positioned on the opposite side of housing 92 so that fans 94A and 94B can push air through housing 92 from one side to the other, as illustrated with arrows in FIG. 2.

FIG. 8 is a block diagram of system circuit architecture 100 for an exemplary curing head of the present disclosure, such as curing head 12. Architecture 100 can include LED array 102, power switch 104, heat sink 106, fans 108A and 108B, bridge 110, LED drivers 112, isolation resistors 114, selector switches 116, AC/DC converter 118, power supply 120, power supply fan 120 and power supply 122.

Power switch 104 can be used to control transmission of power from power supply 122, which can be a battery, to LED array 102. Selector switches 116 can also be configured as switches to individually control power to different banks of LED array 102. For example, as shown in FIG. 8, LED array 102 can include 240 LEDs distributed on twenty four circuit groups. Four circuits can be grouped together and connected to bridge 110 to form six groups. Each group can be connected to one of LED drivers 112, which are each connected to isolation resistors 114. Two groups can be connected to one selector switch 116 to form an LED bank. Thus, selector switches 116 can be used to control one-third of the 240 LEDs. As mentioned, selector switches 116 can be configured as switches in order to allow an operator of architecture 100 to power on less than all of the 240 LEDs.

The term “alkyl” as used herein refers to straight chain and branched alkyl groups having from 1 to 40 carbon atoms (C₁-C₄₀), 1 to about 20 carbon atoms (C₁-C₂₀), 1 to 12 carbons (C₁-C₁₂), 1 to 8 carbon atoms (C₁-C₈), 1 to 6 carbon atoms (C₁-C₈) or, in some embodiments, from 3 to 6 carbon atoms (C₃-C₆). Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups.

The term “alkoxy” as used herein refers to the group —O-alkyl, wherein “alkyl” is defined herein.

The term “aryl” as used herein refers to cyclic aromatic hydrocarbons that do not contain heteroatoms in the ring. Thus, aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons (C₆-C₁₄) or from 6 to 10 carbon atoms (C₆-C₁₀) in the ring portions of the groups.

The term “about” as used herein can allow for a degree of variability in a value or range, for example, within 10%, within 5%, or within 1% of a stated value or of a stated limit of a range.

Unless specified otherwise herein, the term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

### EXAMPLES

The examples described herein are intended solely to be illustrative, rather than predictive, and variations in the manufacturing and testing procedures can yield different results. All quantitative values in the Examples section are understood to be approximate in view of the commonly known tolerances involved in the procedures used. The foregoing detailed description and examples have been given for clarity of understanding only. No unnecessary limitations are to be understood therefrom.

The following abbreviations are used to describe the examples:

° C.: degrees Centigrade

cm: centimeter

cm/min: centimeters per minute

in/min: inches per minute

Kg: kilogram

lb: pound

min: minute

μ-inch: 10⁻⁶ inch

mm: millimeter

μm: micrometer

m/min: meters per minute

mW/cm²: milliwatt per square centimeter

N: Newton

N/mm: Newton per millimeter

pbw: parts by weight

rpm: revolutions per minute

T_{g}: glass transition temperature

UV: ultraviolet

W/cm²: Watts per square centimeter

wt. %: weight percent

Unless stated otherwise, all chemical components were obtained or are available from chemical vendors such as Sigma-Aldrich Company, St. Louis, Mo., or may be synthesized by known methods. Unless otherwise reported, all chemical components (e.g., those listed in Table 1 herein) are parts by weight.

Abbreviations for materials used in the examples are as follows:
CaCO₃: surface-modified calcium carbonate.
CN973H85: aromatic polyester based urethane diacrylate oligomer blended with 15% SR256, 2(2-ethoxyethoxy) ethyl acrylate available from Sartomer Co., West Chester, Pa.
CN982B88: aliphatic polyester based urethane diacrylate oligomer blended with SR238, hexane diol diacrylate available from Sartomer Co., West Chester, Pa.
CN966J75: aliphatic polyester based urethane diacrylate oligomer blended with 25% SR506, isobornyl acrylate available from Sartomer Co., West Chester, Pa.
CN973J75: aromatic polyester based urethane diacrylate oligomer blended with 25% SR506, isobornyl acrylate available from Sartomer Co., West Chester, Pa.
CN991: aliphatic polyester based urethane diacrylate oligomer available from Sartomer Co., West Chester, Pa.
CN9031: urethane acrylate oligomer available from Sartomer Co., West Chester, Pa.
CN131: aromatic monoacrylate oligomer available from Sartomer Co., West Chester, Pa.
CN704: acrylated polyester adhesion promoter available from Sartomer Co., West Chester, Pa.
Genomer 1122: Urethane monoacrylate available from Rahn USA Corp., Aurora, Ill.
DMDO: dimercaptodioxaoctane.
CPQ: camphorquinone.
IRGACURE® 819:

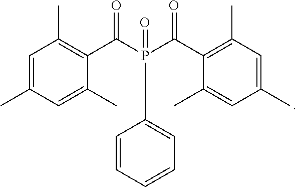

TPO-L:

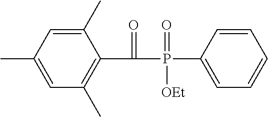 [SMILES: CCOP(=O)(C(=O)c1c(C)cc(C)cc1C)c1ccccc1]

available from BASF Corporation, Wyandotte, Mich.
PLASTHALL® 190: plasticizer available from Hallstar; Chicago, Ill.
CAB-O-SIL® TS-720: fumed silica available from Cabot Corp., Billerica, Mass.
HEMA Phosphate: 2-hydroxy ethyl methacrylate (HEMA) phosphate available from Sigma-Aldrich.
Genorad 40: 2-hydroxy ethyl methacrylate (HEMA) phosphate available from Rahn
Genomer 1122: Urethane monoacrylate available from Rahn
HEMA Succinate: 2-hydroxy ethyl methacrylate (HEMA) succinate available from Sigma-Aldrich.
HEA: 2-hydroxy ethyl acrylate available from TCI Chemicals.
B-CEA: Beta-carboxyethyl acrylate available from Polysciences, Inc.
HFBMA: Heptafluorobutyl methacrylate prepared according to the procedure described in WO 2002/016517, which is incorporated by reference as if fully set forth herein.
PUM: Phosphonic urethane methacrylate synthesized according to Phosphorus, Sulfur, and Silicon and the Related Elements, 179:12, 2617-2626, DOI: 10.1080/10426500490494723.
Isooctyl acrylate: Isooctyl acrylate contains 75-125 ppm monomethyl ether hydroquinone as inhibitor, >90% available from Sigma-Aldrich.
Lubrizol 219: An organic phosphate zinc complex corrosion inhibitor available as Lubrizol 219 Phosphate Zinc Complex from the Lubrizol Corporation, Wickliffe, Ohio.
Lubrizol 541: Dodecenyl succinic acid from the Lubrizol Corporation, Wickliffe, Ohio.
FXR-1020: Fujicure FXR-1020 is a latent-type curing agent and accelerator in a light yellow-colored powder form available from Sanho Chemical Co., Ltd., Taiwan.
Benzotriazole: Benzotriazole available from Sigma Aldrich
CPQ: Camphorquinone available from Sigma Aldrich
Disperse Blue 60: Disperse Blue 60 available from Sigma Aldrich
Oil blue A: Oil blue A available from China Pigments
8368: Urethane seam sealer available from 3M Corporation, St. Paul, Minn.
8369: MSP seam sealer available from 3M Corporation, St. Paul, Minn.
SMT279: Sprayable seam sealer available from FinishMaster, Inc., Indianapolis, Ind.
LORD806HD: One-component, silane-terminated polymer sealer available from Lord Corp., Cary, N.C.
8310: Two-component epoxy sealer available from 3M Corporation, St. Paul
PLIOGRIP®: Urethane adhesive available from Valvoline, Lexington, Ky.
SEM 39377: Two-component epoxy sealer available from SEM Products, Inc., Rock Hill, N.C.

### Example 1-25: Compositions

Examples of compositions of the various embodiments described herein were prepared by combining the components listed herein in Table 1, where the amounts of each component is given in parts by weight (in grams):

TABLE 1

| | Base | | | Irgacure | | Plasthall | Cabosil | | HEMA |
|---|---|---|---|---|---|---|---|---|---|
| Example # | Material | DMDO | CPQ | 819 | TPO-L | 190 | TS-720 | CaCO₃ | Phosphate |
| 1 | A | | 1.7 | | | 86.4 | 17.4 | 29.8 | 10.4 |
| 2 | A | | | 1.7 | | 86.4 | 17.4 | 29.8 | 10.4 |
| 3 | A | | | 5.2 | | 86.4 | 17.4 | 29.8 | 10.4 |
| 4 | A | | | 1.7 | | 86.4 | 17.4 | 119.2 | 10.4 |
| 5 | B | 21.6 | | | 3.5 | 86.4 | 17.4 | 119.2 | 10.4 |
| 6 | B | | | | 3.5 | 86.4 | 17.4 | 119.2 | 10.4 |
| 7 | C | 21.6 | | | 3.5 | 86.4 | 17.4 | 119.2 | 10.4 |
| 8 | C | | | | 3.5 | 86.4 | 17.4 | 119.2 | 10.4 |
| 9 | D | 21.6 | | | 3.5 | 86.4 | 17.4 | 119.2 | 10.4 |
| 10 | D | | | | 3.5 | 86.4 | 17.4 | 119.2 | 10.4 |
| 11 | E | 21.6 | | | 3.5 | 86.4 | 17.4 | 119.2 | 10.4 |
| 12 | E | | | | 3.5 | 86.4 | 17.4 | 119.2 | 10.4 |
| 13 | C | | | 1.7 | | 86.4 | 17.4 | 119.2 | 10.4 |
| 14 | F | | | 1.7 | | 86.4 | 17.4 | 119.2 | 10.4 |
| 15 | D | | | 1.7 | | 86.4 | 17.4 | 119.2 | 10.4 |
| 16 | G | | | 1.7 | | 86.4 | 17.4 | 119.2 | 10.4 |
| 17 | H | | | 1.7 | | 86.4 | 17.4 | 119.2 | 10.4 |
| 18 | I | | | 1.7 | | 86.4 | 17.4 | 119.2 | 10.4 |
| 19 | J | — | — | — | — | — | — | — | — |
| 20 | K | — | — | — | — | — | — | — | — |
| 21 | L | — | — | — | — | — | — | — | — |
| 22 | M | — | — | — | — | — | — | — | — |
| 23 | N | — | — | — | — | — | — | — | — |
| 24 | O | — | — | — | — | — | — | — | — |
| 25 | P | — | — | — | — | — | — | — | — |

A = CN973H85; B = CN982B88; C = CN966J75; D = CN973J75; E = CN991; F = CN9031; G = CN9782; H = CN131; I = CN704; J = 8368; K = 8369; L = SMT 279; M = LORD806HD; N = 8310; O = PLIOGRIP; P = SEM 39377; wherein components A-I are present in 172.8 parts by weight (in grams).

Example compositions were made by charging an amber glass jar with the components listed in Table 1, minus the CaCO₃ and Cabosil TS-720 (silica) filler. The amber glass jar was heated on a hot roller at 80° C. until the components were substantially dissolved. The warm mixture was transferred to an opaque plastic speed mixer jar, whereupon the CaCO₃ and Cabosil TS-720 was added. fillers are added to it. The plastic speed mixer jar was mixed using a speedmixer to mix the fillers with the war mixture at 2000 rpm.

A 25.4 mm×50.8 mm×30 mm rubber mold was placed on a polished steel panel.

The mixtures of the components listed in Table 1, including filler, were placed in the mold. The mixture in the mold was then cured using a light-emitting curing device, such as the curing device shown in FIG. 6, placed approximately 6 mm away from the mold to cure the mixture.

The cured material was released from the mold by peeling the cured material away from the steel panel. If there was uncured material left at the bottom, on the steel panel, the uncured material was removed by scraping away. The thickness of the cured material was measured by caliper.

In some embodiments, longer wavelength absorption photoinitiators are used even though longer wavelength absorption photoinitiators such as Irgacure 819, TPO, TPO-L, have relatively low absorption at longer wavelengths (e.g., 455 nm), there is a small absorption tail that is sufficient to trigger the radical reaction. It may be beneficial to use longer wavelength absorption photoinitiators because the light that is applied to a composition is able to penetrate deeper to achieve at least ¼ inch thickness.

### Example 26: Compositions Comprising Varying Amounts of CaCO₃ Filler

Table 2 lists the depth of cure of compositions prepared according to the various embodiments described herein, wherein the compositions contain differing levels of calcium carbonate and different amounts of photoinitiators. The amount of calcium carbonate appears to affect the depth of cure. A composition of the embodiments containing 38 wt. % calcium carbonate (Example 4) was able to cure 4.9 mm. Comparing with that, the cure on demand seam sealer contains 9.4 wt. % calcium carbonate and 1% Irgacure 819 (Example 2) was able to cure 9.2 mm thick. Although camphorquinone has higher absorption of blue wavelength relative to, say, Irgacure 819, a composition made according to embodiments described herein with 1% camphorquinone (Example 1) only cured 3.9 mm. While not wishing to be bound by any specific theory, it is believed that too high absorption of the photoinitiator could reduce the depth of cure.

Oxygen inhibition is a common issue for photocuring acrylate systems. Example 2 showed oxygen inhibition. After curing, there is an oily layer on the surface of Example 2, which is one sign of oxygen inhibition. But Example 3 demonstrates that oxygen inhibition can be overcome at least by increasing the photoinitiator concentration from 1% to 3%, while still keeping an adequate depth of cure of 8.4 mm.

TABLE 2

| Example # | CaCO₃ | Photoinitiator | Thickness |
|---|---|---|---|
| 1 | 9.4% | 1 wt. % CPQ | 3.9 ± 0.1 mm |
| 2 | 9.4% | 1 wt. % Irgacure 819 | 9.2 ± 0.1 mm |
| 3 | 9.4% | 3 wt. % Irgacure 819 | 8.4 ± 0.2 mm |
| 4 | 38% | 1 wt. % Irgacure 819 | 4.9 ± 0.03 mm |

### Example 27: Evaluation of Physical Properties

Table 3 shows the properties of compositions prepared according to various embodiments described herein, which contain different urethane acrylates. Adequate elongation, elasticity, and low tack are desirable features for a composition. The compositions of examples 8, 10, 13, 15, and 16 have an adequate balance of all three features. Sometimes, adding thiol functional group could increase the elongation. But in some urethane acrylate systems (Example 7 and 9), the compositions were not able to cure with thiol.

TABLE 3

| Example # | Acyrlate | Thiol | Photoinitiator | Results |
|---|---|---|---|---|
| 5 | CN982B88 | DMDO | 2% TPO-L | cure |
| 6 | CN982B88 | | 2% TPO-L | cure |
| 7 | CN966J75 | DMDO | 2% TPO-L | no cure |
| 8 | CN966J75 | | 2% TPO-L | cure |
| 9 | CN973J75 | DMDO | 2% TPO-L | no cure |
| 10 | CN973J75 | | 2% TPO-L | cure |
| 11 | CN991 | DMDO | 2% TPO-L | cure |
| 12 | CN991 | | 2% TPO-L | cure |
| 13 | CN966J75 | | 1% Irgacure 819 | cure |
| 14 | CN9031 | | 1% Irgacure 819 | cure |
| 15 | CN973J75 | | 1% Irgacure 819 | cure |
| 16 | CN9782 | | 1% Irgacure 819 | cure |
| 17 | CN131 | | 1% Irgacure 819 | cure |
| 18 | CN704 | | 1% Irgacure 819 | cure |

### Example 25: Evaluation of Corrosion Resistance

Table 4 shows results of salt spray corrosion test of various compositions prepared according to embodiments described herein (Example 19) compared with 3M 1-part and 2-part sealants and other 1-part and 2-part sealants. A value of 1 or 2 in the corrosion test indicates that the sample failed the corrosion test, whereas a value of 3, 4 and 5 indicates “passing.”

TABLE 4

| Example # | Corrosion |
|---|---|
| 3 | 4 |
| | 5 |
| 19 | 5 |
| | 5 |
| 20 | 2 |
| | 2 |
| 21 | 2 |
| | 2 |
| 22 | 5 |
| | 5 |
| 23 | 1 |
| | 1 |
| 24 | 5 |
| | 5 |
| 25 | 1 |
| | 1 |

Note:
5 = 0% or close to zero after 3 weeks salt spray test;
4 = about 10% corrosion after 3 weeks salt spray test;
3 = about 30% corrosion after 3 weeks salt spray test;
2 = about 50% corrosion after 3 weeks salt spray test;
1 = more than about 70% corrosion after 3 weeks salt spray test.

Corrosion test—apply a composition to about a 1.27 mm (50 mil) thickness on a steel panel. The composition is cured using a light-emitting curing device, such as the curing device shown in FIG. 6, placed approximately 13 mm away from the composition. The cured composition on the steel panel is put in a salt spray chamber for 21 days. The steel panel is removed from the salt spry chamber and the sealer is peeled off from the panel. Whether there is corrosion or not can be observed by eye.

### Example 26-45 and Comparative Examples (CE) 1-3

### Sample Preparation

Examples of compositions of the various embodiments described herein were prepared by combining all the ingredients at various concentration, where the amounts of each component are given in parts by weight (in grams). Samples was made by charging an amber glass jar with the components listed in specific examples, minus the Cabosil TS-720 (silica) filler. The amber glass jar was heated on a hot roller at 80° C. until the components were substantially dissolved. The warm mixture was transferred to an opaque plastic speed mixer jar, where upon the Cabosil TS-720 was added to it.

### T-Peel Test

T-peel test was used to quantitatively measure the adhesion to bare metal. 0.3 inch (0.76 cm)*3 inch (7.6 cm) T-peel specimen was abraded, washed with IPA and air dried right before applying the curing compositions. The mixture was cured from edge at both side of T-peel specimen for 5s by using light-emitting curing device (CF2000 obtained from Clearstone Technologies Inc.) at 100% power, placed approximately 10 mm away to cure the mixture. 180 degree peel test was done at Instron tester at 2.0 inch/min speed. Data was reported as Peel strength (N/mm) and peak load (N). Five specimens for each sample were carried out to get average value and SD value.

### Corrosion Test

To evaluate corrosion resistance properties, an accelerated corrosion test was performed according to ASTM B117. Cure-on-demand materials were coated on fresh abraded cold-rolled steel panels at a thickness of 50 mils (1270 micrometers) and cured by using a light-emitting curing device (CF2000 obtained from Clearstone Technologies Inc.) at 100% power for 5 seconds placed approximately 10 mm away to cure the mixture. 2K Epoxy resin was touched up with a paintbrush to seal the edges. The corrosion test was done by salt spray exposure in an aqueous 5 wt. % sodium chloride solution, supplied with an air-sparging system for 3 weeks. After 3 weeks, samples were removed and the degree of rust was evaluated. Results are presented in Table 6 below, wherein corrosion was evaluated by visual inspection, and was rated as follows:
5=0% or close to zero after 3 weeks salt spray test;
4=about 10% corrosion after 3 weeks salt spray test;
3=about 30% corrosion after 3 weeks salt spray test;
2=about 50% corrosion after 3 weeks salt spray test;
1=more than about 70% corrosion after 3 weeks salt spray test.
   A value of 3, 4 and 5 indicates “passing.”

Cold roll steel panel was abraded, washed with IPA and air dried right before applying the curing compositions. A 25.4 mm×50.8 mm×4.6 mm rubber mold was placed on fresh prepared air dried cold roll steel panel. The mixtures of the components listed in Table 7 were placed in the mold. The mixture in the mold was then cured using a light-emitting curing device, placed approximately 10 mm away from the mold to cure the mixture. The curing time is 5 seconds. After curing, the mold was removed. The color of examples before and after curing was recorded by visual observation.

TABLE 5
Formulation

| | | | | | | | 2-carboxyethyl | HEMA |
|---|---|---|---|---|---|---|---|---|
| Sample # | CN973H85 | Genomer1122 | CN131B | Genorad40 | PUM | SR339 | acrylate | succinate |
| EX-26 | 31.50 | 49.00 | | 9.00 | | | | |
| EX-27 | 31.50 | 36.00 | | 22.00 | | | | |
| EX-28 | 31.50 | 49.00 | | | 9.00 | | | |
| EX-29 | 44.75 | | 44.75 | | | | | |
| EX-30 | 30.70 | | 48.25 | 8.77 | | | | |
| EX-31 | 31.50 | 36.00 | | | | | 22.00 | |
| EX-32 | 31.50 | 36.00 | | | | | | 22.0 |
| EX-33 | 43.86 | 17.54 | | 26.32 | | | | |
| EX-34 | 8.60 | 53.40 | | 25.90 | | | | |
| EX-35 | 30.70 | | | 8.77 | | 48.25 | | |
| EX-36 | 8.77 | 70.18 | | 8.77 | | | | |
| EX-37 | 8.60 | 51.70 | | 25.90 | | | | |
| EX-38 | 29.41 | 46.22 | | 8.40 | | | | |
| EX-39 | 29.41 | 46.22 | | 8.40 | | | | |
| EX-40 | 30.17 | 47.41 | | 8.62 | | | | |
| EX-41 | 29.41 | 46.22 | | 8.40 | | | | |
| EX-42 | 29.91 | 47.01 | | 8.55 | | | | |
| CE-1 | 44.75 | | | | | | | 44.75 |
| CE-2 | 76.50 | | | 13.00 | | | | |
| CE-3 | 72.50 | | | 17.00 | | | | |

| | Irgacure | Cabosil | | | Lubrizol | Lubrizol | |
|---|---|---|---|---|---|---|---|
| Sample # | 819 | TS-720 | Benzotriazole | FXR1020 | 219 | 541 | IOA |
| EX-26 | 4.50 | 6.00 | | | | | |
| EX-27 | 4.50 | 6.00 | | | | | |
| EX-28 | 4.50 | 6.00 | | | | | |
| EX-29 | 4.50 | 6.00 | | | | | |
| EX-30 | 4.39 | 7.89 | | | | | |
| EX-31 | 4.50 | 6.00 | | | | | |
| EX-32 | 4.50 | 6.00 | | | | | |
| EX-33 | 4.39 | 7.89 | | | | | |
| EX-34 | 4.30 | 7.80 | | | | | |
| EX-35 | 4.39 | 7.89 | | | | | |
| EX-36 | 4.39 | 7.89 | | | | | |
| EX-37 | 4.30 | 7.80 | 1.70 | | | | |
| EX-38 | 4.20 | 7.56 | | 4.20 | | | |
| EX-39 | 4.20 | 7.56 | | | 4.20 | | |
| EX-40 | 4.31 | 7.76 | | | 1.72 | | |
| EX-41 | 4.20 | 7.56 | | | | 4.20 | |
| EX-42 | 4.27 | 7.69 | | | | | 2.56 |
| CE-1 | 4.50 | 6.00 | | | | | |
| CE-2 | 4.50 | 6.00 | | | | | |
| CE-3 | 4.50 | 6.00 | | | | | |

TABLE 6
Adhesion and corrosion performance

| Sample # | T-peel (N/mm) | Peak load (N) | Corrosion rating |
|---|---|---|---|
| EX-26 | 4.4 ± 0.2 | 47.5 ± 11.7 | 5 |
| EX-27 | 3.3 ± 0.2 | 36.6 ± 6.8 | 4 |
| EX-28 | 4.2 ± 0.4 | 37.3 ± 5.4 | 5 |
| EX-29 | 2.5 ± 0.5 | 38.5 ± 5.9 | 4 |
| EX-30 | 3.9 ± 0.6 | 57.6 ± 2.6 | 4 |
| EX-31 | 5.7 ± 0.3 | 56.6 ± 6.2 | 4 |
| EX-32 | 6.3 ± 0.4 | 73.4 ± 16.8 | 4 |
| EX-33 | 2.6 ± 0.2 | 62.1 ± 10.9 | 4 |
| EX-34 | 3.0 ± 0.1 | 51.0 ± 13.1 | 4 |
| EX-35 | 3.1 ± 0.7 | 42.1 ± 10.8 | 5 |
| EX-36 | 5.5 ± 1.3 | 50.8 ± 5.9 | 5 |
| EX-37 | 3.1 ± 0.2 | 51.6 ± 8.1 | 5 |
| EX-38 | 3.0 ± 0.1 | 47.2 ± 5.7 | 5 |
| EX-39 | 2.5 ± 0.1 | 43.3 ± 5.6 | 5 |
| EX-40 | 3.7 ± 0.1 | 46.8 ± 4.5 | 5 |
| EX-41 | 2.5 ± 0.4 | 43.6 ± 13.7 | 5 |
| EX-42 | 3.6 ± 0.3 | 40.8 ± 6.6 | 5 |
| CE-1 | 3.8 ± 0.2 | 56.5 ± 5.8 | 1 |
| CE-2 | 1.4 ± 0.3 | 16.4 ± 3.9 | 4 |
| CE-3 | 1.9 ± 0.2 | 20.9 ± 2.7 | 1 |

Overall, the results presented in these examples demonstrate a new light curable, one part acrylic sealant composition having a depth of cure up to 30 mm and possessing strong adhesion to bare metal after 3-5 s light exposure. The T-peel strength (>2 N/mm) is comparable with current 2K epoxy and 1K MSP and urethane product. Good corrosion resistance was obtained.

TABLE 7
Formulation with photobleaching dye and its color before and after curing

| | | | | | | Disperse | Oil | | | | |
|---|---|---|---|---|---|---|---|---|---|---|---|
| | | | | Plasthall | Heptafluorobutyl | blue | blue | | Irgacure | Cabosil | |
| Sample # | CN973H85 | Genomer1122 | Genorad40 | 190 | methacrylate | 60 | A | CPQ | 819 | TS-720 | CaCO₃ |
| EX-43 | 30.50 | 34.896 | 21.80 | | 2.70 | 0.002 | | 0.002 | 4.40 | 5.70 | |
| EX-44 | 53.65 | | 3.23 | 26.846 | | 0.002 | | 0.002 | 1.62 | 5.40 | 9.25 |
| EX-45 | 53.65 | | 3.23 | 26.846 | | | 0.002 | 0.002 | 1.62 | 5.40 | 9.25 |

TABLE 8
Color change before and after light exposure

| Sample # | Color before light exposure | Color after light exposure |
|---|---|---|
| EX-43 | green | Light yellow |
| EX-44 | green | Light yellow |
| EX-45 | blue | Light yellow |

As shown in Table 8, the examples before curing show blue-green color, upon 5 second exposure with a LED curing light, the resin bleached from blue-green to light yellow (nearly colorless). Overall, the compositions of the invention have an initial color prior to exposure to actinic radiation and have a different, final color subsequent to exposure to actinic radiation.

1. A method comprising:
applying a composition to a substrate, the composition comprising
a urethane acrylate component;
an adhesion promoter comprising an acid-functional monomer; and
a photoinitiator having an extinction coefficient of from about 10 to about 2000 L/mol·cm at a wavelength from about 400 nm to about 500 nm in an amount of from about 0.1 wt. % to about 10 wt. %; and
curing the composition using a light-emitting curing device emitting light at a wavelength of from about 260 to about 550 nm;
wherein the composition cures to a depth of cure of up to about 30 mm within about 0.5 second to about two minutes per light exposure area.

2. The method of claim 1, wherein the composition further comprises at least one of about 3 to about 50 wt. % of adhesion promoter, about 10 to about 80 wt. % of diluents, about 0.3 to about 10 wt. % long alkyl chain (meth)acrylate, about 0.3 to about 10 wt. % of fluorinated (meth)acrylate, about 0.5 to about 10 wt. % of corrosion inhibitor, about 1 to about 200 ppm of photobleaching agent, about 1 to about 200 ppm of photosensitizer, about 0.1 to about 30 wt. % of fillers, about 0.5 to about 30 wt. % of monothiols, polythiols, or combination thereof, and about 1 to about 40 wt. % of plasticizer.

3. (canceled)

4. (canceled)

5. The method of claim 1, wherein the composition comprises about 5 wt. % to about 85 wt. % urethane acrylate component.

6. (canceled)

7. (canceled)

8. (canceled)

9. The method of claim 1, wherein the urethane acrylate component comprises an aliphatic urethane acrylate, an aromatic urethane acrylate, or a combination of an aliphatic urethane acrylate and an aromatic urethane acrylate.

10. (canceled)

11. The method of claim 1, wherein the photoinitiator comprises

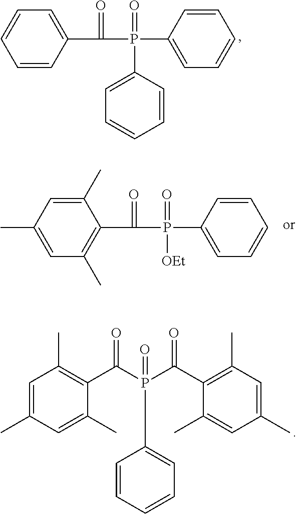

12. The method of claim 2, wherein the filler comprises calcium carbonate (CaCO₃), silica, glass bubbles, glass flakes, or talc.

13. (canceled)

14. (canceled)

15. (canceled)

16. (canceled)

17. (canceled)

18. (canceled)

19. (canceled)

20. The method of claim 2, wherein the adhesion promoter comprises acrylic acid (AA), methacrylic acid (MAA), beta-carboxyethyl acrylate (B-CEA); 2-hydroxy ethyl methacrylate (HEMA) Succinate; 2-hydroxy ethyl methacrylate (HEMA) phosphate; (meth) acrylic phosphonic acids and esters; (meth) acrylic phosphoric acids and esters; (3-acryloxypropyl)trimethoxysilane, methacryloxypropyltrimethoxysilane, or combinations thereof.

21. The method of claim 1, wherein the substrate is an automotive body part requiring sealing.

22. The method of claim 21, where in the automotive body parts include door, fender, quarter panel, hood, deck lid, roof, floor, rocker panel, wheel house, cowl, and frame/structural members.

23. (canceled)

24. (canceled)

25. (canceled)

26. (canceled)

27. (canceled)

28. A curing device comprising:
a curing head including:
an emitter comprising an elongate array of light emitting diodes (LEDs) arranged in alternating columns, wherein rows of LEDs in each individual column are offset from each other by about 1.5 mm to about 12 mm and each individual LED is offset by about 1.5 mm to about 12 mm from each other;
a chassis to which the curing head is mounted; and
a housing at least partially enclosing the chassis and curing head;
wherein the curing device emits light at a wavelength of from about 400 nm to about 500 nm; and the curing device has a radiometric energy of about at least about 0.1 W/cm².

29. (canceled)

30. The curing device of claim 28, further comprising at least one heat sink bank mounted to the chassis, opposite the emitter, wherein the chassis is in direct or indirect thermal communication with the emitter.

31. The curing device of claim 28, further comprising one or more fans mounted on the curing head to direct an airflow across the emitter or heat sink assembly.

32. A composition comprising:
a urethane acrylate (e.g., multi-functional urethane acrylate);
a reactive diluent;
an adhesion promoter comprising an acid-functional monomer;
a photoinitiator having an extinction coefficient of from about 10 to about 2000 L/mol·cm at a wavelength from about 400 nm to about 500 nm;
a photobleaching agent;
a photosensitizer; and
a filler.

33. The composition of claim 32, wherein the reactive diluent is a low viscosity acrylate monomer.

34. (canceled)

35. (canceled)

36. (canceled)

37. The composition of claim 32, wherein the adhesion promoter comprises acrylic acid (AA), methacrylic acid (MAA), beta-carboxyethyl acrylate (B-CEA); 2-hydroxy ethyl methacrylate (HEMA) Succinate; 2-hydroxy ethyl methacrylate (HEMA) phosphate; (meth) acrylic phosphonic acids and esters; (meth) acrylic phosphoric acids and esters; or combinations thereof.

38. The composition of claim 32, wherein the composition comprises about 5 wt. % to about 85 wt. % multi-functional urethane acrylate; about 10 wt. % to about 80 wt. % reactive diluent; about 3 wt. % to about 50 wt. % adhesion promoter; about 0.1 wt. % to about 8 wt. % photoinitiator; about 1 ppm to about 200 ppm photobleaching agent; about 1 ppm to about 200 ppm photosensitizer; and about 0.1 wt. % to about 30 wt. % filler.

39. (canceled)

40. (canceled)

41. (canceled)

42. (canceled)

43. (canceled)

44. The composition of claim 32, wherein the urethane acrylate comprises an aliphatic urethane acrylate, an aromatic urethane acrylate, or a combination of an aliphatic urethane acrylate and an aromatic urethane acrylate.

45. (canceled)

46. The composition of claim 32, wherein the photoinitiator comprises

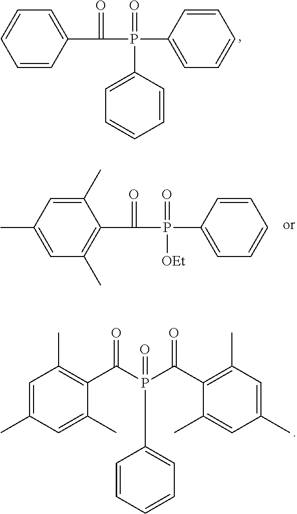

47. (canceled)

48. The composition of claim 32, wherein the photobleaching agent comprises Disperse blue 60, or oil blue A.

49. The composition of claim 32, wherein the filler comprises calcium carbonate (CaCO₃), silica, glass bubbles, glass flakes or talc.

50. (canceled)

51. (canceled)

52. (canceled)

53. (canceled)
